(19) United States
(12) Patent Application Publication
(10) Pub. No.: US 2020/0267385 A1
(43) Pub. Date: Aug. 20, 2020

(54) METHOD FOR PROCESSING SYNCHRONISED IMAGE, AND APPARATUS THEREFOR

(71) Applicant: KAONMEDIA CO., LTD., Seongnam-si, Gyeonggi-do (KR)

(72) Inventors: Jeong Yun LIM, Seoul (KR); Hoa Sub LIM, Seongnam-si, Gyeonggi-do (KR)

(21) Appl. No.: 16/628,875

(22) PCT Filed: Jul. 6, 2018
(86) PCT No.: PCT/KR2018/007702

§ 371 Date: Jan. 6, 2020

(30) Foreign Application Priority Data
Jul. 6, 2017 (KR) 10-2017-0086115
Jul. 12, 2017 (KR) 10-2017-0088456

(51) Int. Cl. H04N 19/117; H04N 19/176; H04N 19/186; H04N 19/52; H04N 19/167

(52) U.S. Cl. CPC H04N 19/117; H04N 19/176; H04N 19/167; H04N 19/52; H04N 19/186

(57) ABSTRACT

Provided is a decoding method performed by a decoding apparatus, and the method includes the steps of: performing decoding of a current block on a current picture configured of a plurality of temporally or spatially synchronized regions, and the step of performing decoding includes the step of performing decode processing of the current block using region information corresponding to the plurality of regions.

### BACKGROUND OF THE INVENTION

### Field of the Invention

The present invention relates to a video processing method and an apparatus thereof. More specifically, the present invention relates to a method of processing a synchronized region-based video and an apparatus thereof.

### Background of the Related Art

Recently, studies on virtual reality (VR) technology for reproducing real world and giving vivid experience are being actively proceeded according to developments of digital video processing and computer graphics technology.

Especially, since recent VR system such as HMD (Head Mounted Display) can not only provide three-dimensional solid video to user's both eyes, but also perform tracking of view point omnidirectionally, it is watched with much interest that it can provide vivid virtual reality (VR) video contents which can be watched with 360 degrees rotation.

However, since 360 VR contents are configured with concurrent omnidirectional multi-view video information which is complexly synchronized with time and both eyes video spatially, in production and transmission of video, two synchronized large-sized videos should be compressed and delivered with respect to both eyes space of all the view points. This cause aggravation of complexity and bandwidth burden, and especially at a decoding apparatus, there comes a problem that decoding on regions off the track of user's view point and actually not watched is performed, by which unnecessary process is wasted.

Accordingly, it is required to provide an efficient encoding method from the aspect of bandwidth and battery consumption of a decoding apparatus, while reducing the amount of transmission data and complexity of videos.

In addition, in the case of the 360-degree VR contents as described above, videos acquired through two or more cameras should be processed by the view region, and in the case of videos acquired through different cameras, the overall brightness or the like of the videos are acquired differently in many cases due to the characteristics of the cameras and the external environment at the time of acquiring the videos. As a result, there is a problem in that the subjectively sensed video quality is lowered greatly in implementing decoding results as 360-degree VR contents.

In addition, when the videos acquired through the cameras are integrated into a large-scale video for a 360-degree video, there is also a problem in that encoding efficiency or video quality is lowered due to generated boundaries.

### SUMMARY OF THE INVENTION

The present invention is to settle the problem as mentioned above, and the object thereof is to provide a video processing method and an apparatus thereof, which can efficiently encode and decode synchronized multi-view videos, such as videos for 360-degree cameras or VR, using spatial layout information of the synchronized multi-view videos.

In addition, another object of the present invention is to provide a video processing method and an apparatus thereof, which can provide illumination compensation for preventing degradation of subjectively sensed video quality caused by inconsistency of synchronized view regions of synchronized multi-view videos such as videos for 360-degree cameras or VR or inconsistency of illumination of each region.

In addition, another object of the present invention is to provide a video processing method and an apparatus thereof, which can prevent degradation of subjectively sensed video quality caused by inconsistency of synchronized view regions of synchronized multi-view videos such as videos for 360-degree cameras or VR and degradation of encoding efficiency caused by matching, and maximize enhancement of video quality compared with the efficiency.

According to an embodiment of the present invention for solving above-mentioned technical problem, there is provided a decoding method performed by a decoding apparatus, the method including the steps of performing motion prediction decoding of a current block on a current picture configured of a plurality of temporally or spatially synchronized regions, and the step of performing motion prediction decoding includes the steps of deriving a neighboring reference region corresponding to a region to which the current block belongs; acquiring an illumination compensation parameter of the reference region; and processing illumination compensation of the current block, on which the motion prediction decoding is performed, using the illumination compensation parameter.

According to an embodiment of the present invention for solving above-mentioned technical problem, there is provided a decoding apparatus including a video decoding unit for performing motion prediction decoding of a current block on a current picture configured of a plurality of temporally or spatially synchronized regions; and an illumination compensation processing unit for deriving a neighboring reference region corresponding to a region to which the current block belongs, acquiring an illumination compensation parameter of the reference region, and processing illumination compensation of the current block, on which the motion prediction decoding is performed, using the illumination compensation parameter.

According to an embodiment of the present invention for solving above-mentioned technical problem, there is provided a decoding method performed by a decoding apparatus, the method including the step of performing decoding of a current block on a current picture configured of a plurality of synchronized regions, in which the step of performing decoding includes the steps of: identifying a boundary region between a region to which the current block belongs and a neighboring region; and applying selective filtering corresponding to the boundary region.

In addition, according to an embodiment of the present invention for solving above-mentioned technical problem, there is provided a decoding apparatus including a video decoding unit for performing decoding of a current block on a current picture configured of a plurality of synchronized regions, and the video decoding unit identifies a boundary region between a region to which the current block belongs and a neighboring region, and applies selective filtering corresponding to the boundary region.

In addition, according to an embodiment of the present invention for solving above-mentioned technical problem, there is provided an encoding apparatus including a video encoding unit for performing encoding of a current block on a current picture configured of a plurality of synchronized regions, and the video encoding unit identifies a boundary region between a region to which the current block belongs and a neighboring region, and applies selective filtering corresponding to the boundary region.

On the other hand, a method according to an embodiment of the present invention for solving above-mentioned technical problem may be implemented as a program for executing the method in a computer and a recording medium recording the program.

### BRIEF DESCRIPTION OF THE DRAWINGS

FIG. 1 shows an overall system structure according to an embodiment of the present invention.

FIG. 2 is a block diagram showing structure of video encoding apparatus according to an embodiment of the present invention.

FIG. 3 to FIG. 6 are diagrams showing examples of spatial layouts of synchronized multi-view video according to embodiments of the present invention.

FIG. 7 to FIG. 9 are tables for explanation of signaling method of spatial layout information according to a variety of embodiments of the present invention.

FIG. 10 is a table for explanation of structure of spatial layout information according to an embodiment of the present invention.

FIG. 11 is a diagram for explanation of type index table of spatial layout information according to an embodiment of the present invention.

FIG. 12 is a flow chart for explanation of decoding method according to an embodiment of the present invention.

FIG. 13 is a diagram showing decoding system according to an embodiment of the present invention.

FIG. 14 and FIG. 15 are diagrams for explanation of encoding and decoding processing according to an embodiment of the present invention.

FIG. 16 and FIG. 17 are flow charts for explanation of a decoding method of processing illumination compensation based on a region parameter according to an embodiment of the present invention.

FIG. 18 is a diagram for explanation of a region area of a synchronized multi-view video and spatially neighboring regions according to an embodiment of the present invention.

FIG. 19 is a diagram for explanation of temporally neighboring regions according to an embodiment of the present invention.

FIG. 20 is a diagram for explanation of region adaptive filtering according to an embodiment of the present invention.

FIG. 21 is a flow chart for explanation of a decoding method according to an embodiment of the present invention.

FIG. 22 to FIG. 30 are diagrams for explanation of selective filtering corresponding to a region boundary region according to an embodiment of the present invention.

### DETAILED DESCRIPTION OF THE PREFERRED EMBODIMENT

Hereinafter, some embodiments of the present invention will be described in detail with reference to attached drawings, for a person having ordinary knowledge in the technical field in which the present invention pertains to implement it with ease. However, the present invention may be realized in a variety of different forms, and is not limited such embodiments depicted herein. And, for clarity of description of the present invention, some units in drawings which are not relevant to description may be omitted, and throughout the overall specification, like reference numerals designate like elements.

Throughout the specification of the present invention, when a unit is said to be “connected” to another unit, this includes not only a case where they are “directly connected”, but also a case where they are “electrically connected” with other element sandwiched therebetween.

Throughout the specification of the present invention, when a member is said to be placed on another member, this includes not only a case where a member contacts another member, but also a case where more another member exists between two members.

Throughout the specification of the present invention, when a unit is said to “include” an element, this means not excluding other elements, but being able to include further elements. Words for degree such as “about”, “practically”, and so on used throughout the specification of the present invention are used for meaning of proximity from the value or to the value, when a production and material tolerance is provided proper to a stated meaning, and are used to prevent a disclosed content stated with exact or absolute value for facilitating understanding the present invention from being abused by an unconscionable infringer. Words of “step of ˜ing” or “step of ˜” used throughout the specification of the present invention do not mean “step for ˜”.

Throughout the specification of the present invention, wording of combination thereof included in Markush format means mixture or combination of one or more selected from a group consisting of elements written in expression of Markush format, and means including one or more selected from a group consisting of the elements.

In an element of the present invention, as an example of method for encoding synchronized video, encoding may be performed using HEVC (High Efficiency Video Coding) standardized commonly by MPEG (Moving Picture Experts Group) and VCEG (Video Coding Experts Group) having the highest encoding efficiency among video encoding standards developed until now or using an encoding technology which is currently under standardization, but not limited to such.

In general, an encoding apparatus includes encoding process and decoding process, while a decoding apparatus is furnished with decoding process. The decoding process of decoding apparatus is the same as that of encoding apparatus. Therefore, hereinafter, an encoding apparatus will be mainly described.

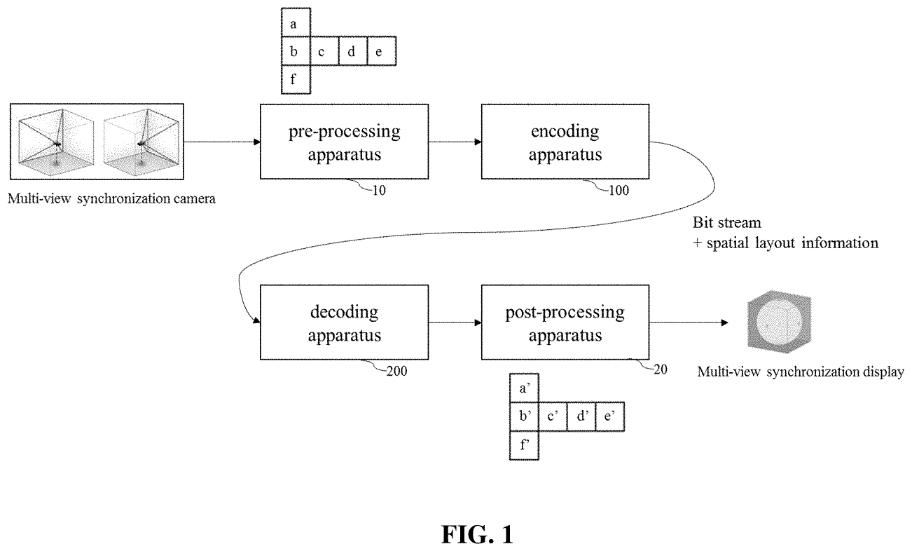

FIG. 1 shows the whole system structure according to an embodiment of the present invention.

Referring to FIG. 1, the whole system according to an embodiment of the present invention includes a pre-processing apparatus 10, an encoding apparatus 100, a decoding apparatus 200, and a post-processing apparatus 20.

A system according to an embodiment of the present invention may comprise the pre-processing apparatus 10 acquiring synchronized video frame, by pre-processing through work such as merge or stitch on a plurality of videos by view point, the encoding apparatus 100 encoding the synchronized video frame to output bitstream, the decoding apparatus 200 being transmitted with the bitstream and decoding the synchronized video frame, and the post-processing apparatus 20 post-processing the video frame for making synchronized video of each view point be output to each display.

Here, input video may include individual videos by multi-view, and for example, may include sub image information of a variety of view points photographed at a state in which one or more cameras are synchronized with time and space. Accordingly, the pre-processing apparatus 10 can acquire synchronized video information, by spatial merge or stitch processing acquired multi-view sub image information by time.

And, the encoding apparatus 100 may process scanning and prediction encoding of the synchronized video information to generate bitstream, and the generated bitstream may be transmitted to the decoding apparatus 200. Especially, the encoding apparatus 100 according to an embodiment of the present invention can extract spatial layout information from the synchronized video information, and can signal to the decoding apparatus 200.

Here, spatial layout information may include basic information on property and arrangement of each sub images, as one or more sub images are merged and configured into one video frame from the pre-processing apparatus 10. And, additional information on each of sub images and relationship between sub images may be further included, which will be described in detail later.

Accordingly, spatial layout information according to an embodiment of the present invention may be delivered to the decoding apparatus 200. And, the decoding apparatus 200 can determine decoding object and decoding order of bitstream, with reference to spatial layout information and user perspective information, which may lead to efficient decoding.

And, decoded video frame is divided again into sub images by each display through the post-processing apparatus 20, to be provided to a plurality of synchronized display system such as HMD, by which user can be provided with synchronized multi-view video with sense of reality such as virtual reality.

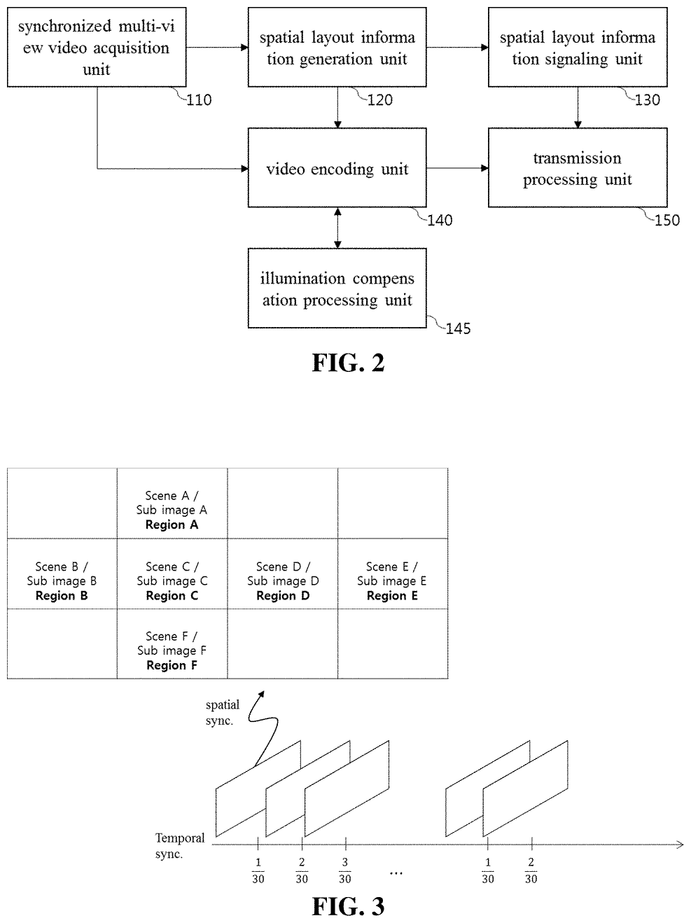

FIG. 2 is a block diagram showing structure of time synchronized multi-view video encoding apparatus according to an embodiment of the present invention.

Referring to FIG. 2, the encoding apparatus 100 according to an embodiment of the present invention includes a synchronized multi-view video acquisition unit 110, a spatial layout information generation unit 120, a spatial layout information signaling unit 130, a video encoding unit 140, an illumination compensation processing unit 145, and a transmission processing unit 150.

The synchronized multi-view video acquisition unit 110 may acquire synchronized multi-view video, using synchronized multi-view video acquisition means such as 360 degrees camera. The synchronized multi-view video may include a plurality of sub images with time and space synchronization, and may be received from the pre-processing apparatus 10 or may be received from a separate foreign input apparatus.

And, the spatial layout information generation unit 120 may divide the synchronized multi-view video into video frames by time unit to extract spatial layout information with respect to the video frame. The spatial layout information may be determined according to state of property and arrangement of each sub image, or alternatively, may also be determined according to information acquired from the pre-processing apparatus 10.

And, the spatial layout information signaling unit 130 may perform information processing for signaling the spatial layout information to decoding apparatus 200. For example, the spatial layout information signaling unit 130 may perform one or more process, for having being included in encoded video data at video encoding unit, for configuring further data format, or for having being included in meta-data of encoded video.

And, the video encoding unit may perform encoding of synchronized multi-view video according to time flow. And, the video encoding unit may determine video scanning order, reference image, and the like, using spatial layout information generated at the spatial layout information generation unit 120 as reference information.

Therefore, the video encoding unit 140 may perform encoding using HEVC (High Efficiency Video Coding) as described above, but can be improved in more efficient way as to synchronized multi-view video according to spatial layout information.

In the video encoding processed by the video encoding unit 140, when motion prediction decoding of the current block on the current picture is performed, the illumination compensation processing unit 145 derives a neighboring reference region corresponding to a region in which the current block belongs, acquires an illumination compensation parameter of the reference region, and processes illumination compensation of the current block, on which the motion prediction decoding is performed, using the illumination compensation parameter.

Here, the sub images processed and temporally or spatially synchronized by the pre-processing apparatus 10 may be arranged on each picture configured of a plurality of regions. The sub images are acquired through different cameras or the like and may be stitched or merged according to video processing at the pre-processing apparatus 10. However, the sub images acquired through the cameras may not be uniform in overall brightness due to the external environment or the like at the time of photographing, and therefore, degradation of subjective video quality and reduction of coding efficiency may occur due to inconsistency.

Accordingly, in an embodiment of the present invention, an area of the stitched and merged sub images may be referred to as a region, and in encoding of the video encoding unit 140, the illumination compensation processing unit 145 may compensate for inconsistency of illumination generated by different cameras by performing illumination compensation processing based on an illumination compensation parameter acquired for a region temporally or spatially neighboring to the current region as described above, and an effect of improving video quality and enhancing encoding efficiency according thereto can be obtained.

Especially, the layout of each picture synchronized to a specific time may be determined according to a merge and stitch method of the pre-processing apparatus 10. Accordingly, regions in a specific picture may have a relation spatially neighboring with each other by the layout, or regions at the same position of different pictures may have a relation temporally neighboring with each other, and the illumination compensation processing unit 145 may acquire information on the neighboring relation like such from spatial layout information of the video information or from the video encoding unit 140.

Therefore, the illumination compensation processing unit 145 may determine the neighboring region information corresponding to the current region and the illumination compensation parameter corresponding to the neighboring region information and accordingly may perform illumination compensation processing on a decoded block identified from the video encoding unit 140.

Especially, according to an embodiment of the present invention, preferably, the illumination compensation processing may be applied to motion compensation processing of the video encoding unit 140. The video encoding unit 140 may deliver a motion prediction sample or information on a block matched and restored with respect to the motion prediction sample according to motion compensation, and the illumination compensation processing unit 145 may perform illumination compensation processing on the motion prediction sample according to the neighboring region information and the illumination compensation parameter or the block matched and restored with respect to the motion prediction sample according to the motion compensation.

More specifically, the illumination compensation parameter may include illumination scale information and illumination offset information calculated in advance in correspondence to a reference target region. The illumination compensation processing unit 145 may apply the illumination scale information and the illumination offset information to the motion prediction sample or the matched and restored block, and deliver the illumination-compensated motion prediction sample or the matched and restored block to the video encoding unit 140.

In addition, the illumination compensation processing unit 145 may signal at least one of the neighboring region information and the illumination compensation parameter to the decoding apparatus 200 or the post-processing apparatus 20 through the transmission processing unit 150. The operation of the decoding apparatus 200 or the post-processing apparatus 20 will be described later.

And, the transmission processing unit 150 may perform one or more transform and transmission processing for combining encoded video data, spatial layout information inserted from the spatial layout information signaling unit 130, and the neighboring region information or the illumination compensation parameter to transmit to the decoding apparatus 200 or the post-processing apparatus 20.

FIG. 3 to FIG. 6 are diagrams showing an example of spatial layout and video configuration of synchronized multi-view video according to an embodiment of the present invention.

Referring to FIG. 3, multi-view video according to an embodiment of the present invention may include a plurality of video frames which are synchronized in time-base and space-base.

Each frame may be synchronized according to distinctive spatial layout, and may configure layout of sub images corresponding to one or more scene, perspective or view which will be displayed at the same time.

Accordingly, the spatial layout information may include sub images and related information thereof such as arrangement information of the multi-view video or sub images, position information and angle information of capture camera, merge information, information of the number of sub images, scanning order information, acquisition time information, camera parameter information, reference dependency information between sub images, in case that each of sub images configuring synchronized multi-view video is configured to one input video through merge, stitch, and the like, or in case that concurrent multi-view video (for example, a plurality of videos synchronized at the same time, which is corresponding to a variety of views corresponding in the same POC) is configured to input video.

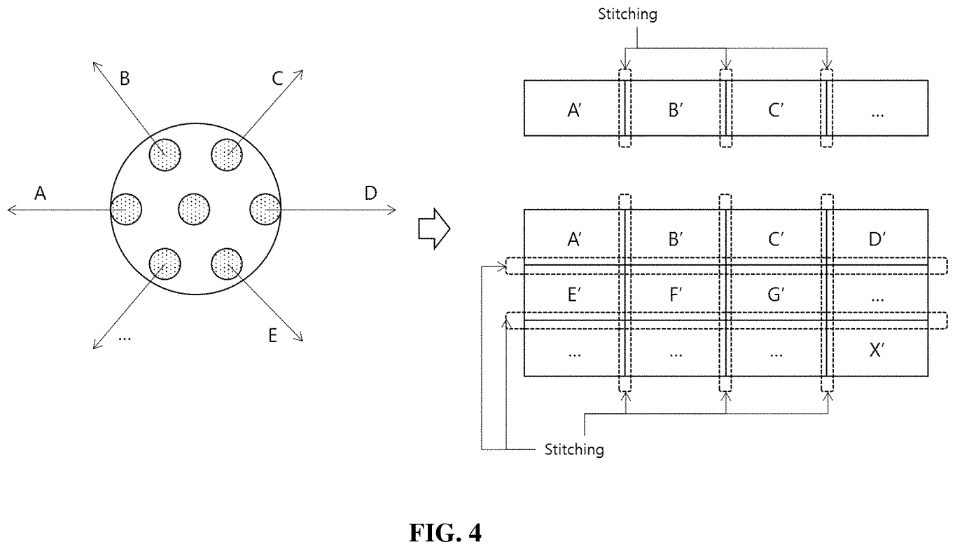

For example, as shown in FIG. 4, through camera arrangement of divergent form, video information may be photographed, and through stitch processing (stitching) on arranged video, space video observable over 360 degrees can be configured.

As shown in FIG. 4, videos A′, B′, C′, . . . photographed corresponding to each camera arrangement A, B, C, . . . may be arranged according to one-dimensional or two-dimensional spatial layout, and left-right and top-bottom region relation information for stitch processing between arranged videos may be illustrated as a spatial layout information.

Accordingly, the spatial layout information generation unit 120 may extract spatial layout information including a variety of properties as described above from input video, and the spatial layout information signaling unit 130 may signal the spatial layout information by an optimized method which will be described later.

As described above, generated and signaled spatial layout information may be utilized as a useful reference information as described above.

For example, when content photographed through each camera is pre-stitched image, before encoding, each of the pre-stitched images may overlap to configure one scene. On the other hand, the scene may be separated by each view, and mutual compensation between images separated each by type may be realized.

Accordingly, in case of pre-stitched image in which one or more videos photographed at multi-view are merged and stitched into one image in pre-processing process to be delivered to input of encoder, scene information, spatial layout configuration information, and the like of merged and stitched input video may be delivered to encoding step and decoding step through separate spatial layout information signaling.

And, also in case of non-stitched image video type in which videos acquired at multi-view are delivered to one or more input videos with time-based synchronized view point to be encoded and decoded, they may be referred and compensated according to the spatial layout information at encoding and decoding steps. For the above, a variety of spatial layout information and data fields corresponding thereto may be necessary. And, data field may be encoded with compression information of input video, or may be transmitted with being included in separate meta-data.

And, data field including spatial layout information may be further utilized in the post-processing apparatus 20 of video and rendering process of display.

For the above, data field including spatial layout information may include position coordinate information and chrominance information acquired at the time of acquiring video from each camera.

For example, information such as three-dimensional coordinate information and chrominance information (X, Y, Z), (R, G, B) of video acquired at the time of acquisition of video information from each camera may be acquired and delivered as additional information on each of sub images, and such information may be utilized at post-processing and rendering process of video, after performing decoding.

And, data field including spatial layout information may include camera information of each camera.

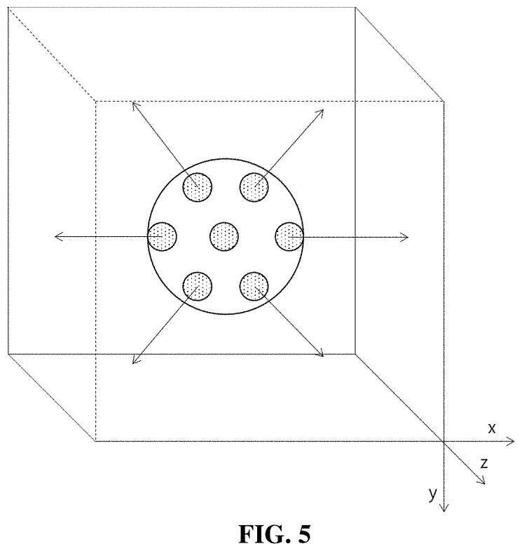

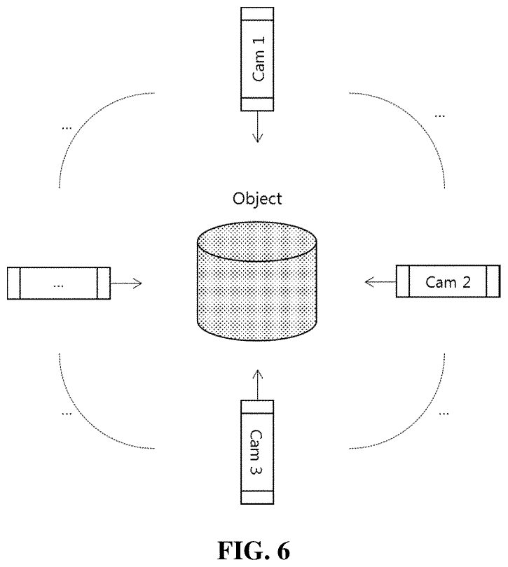

As shown in FIG. 5 and FIG. 6, one or more camera may be arranged photographing three-dimensional space to provide space video.

For example, as shown in FIG. 5, at the time of video acquisition, positions of one or more cameras may be fixed at center position and each direction may be set in the form of acquiring peripheral objects at one point in three-dimensional space.

And, as shown in FIG. 6, one or more cameras may be arranged in the form of photographing one object at a variety of angle. At this time, based on coordinate information (X, Y, Z), distance information, and the like at the time of video acquisition, user's motion information (Up/Down, Left/Right, Zoom in/Zoom Out) and the like is analysed at VR display device for playing three-dimensional video, and a portion of video corresponding to the above is decoded or post-processed, to be able to restored video of view point of portion wanted by user. On the other hand, as described above, in system such as compression, transmission, and play of synchronized multi-view video illustrated as VR video, separate video converting tool module and the like may be added, according to type or characteristics of video, characteristics of decoding apparatus and the like.

For example, when video acquired from camera is Equirectangular type, the video encoding unit 140 may convert it to video type of form of Icosahedron/cubemap and the like through converting tool module according to compression performance and encoding efficiency and the like of video to perform encoding thereby. Converting tool module at this time may be further utilized in pre-processing apparatus 10 and post-processing apparatus 20, and convert information according to transform may be delivered to decoding apparatus 200, post-processing apparatus 20 or VR display apparatus in a form of meta-data with being included in the spatial layout information and the like.

On the other hand, to deliver synchronized multi-view video according to an embodiment of the present invention, separate VR video compression method to support scalability between encoding apparatus 100 and decoding apparatus 200 may be necessary.

Accordingly, the encoding apparatus 100 may implement compression encoding of video, in the way of dividing base class and improvement class, to compress VR video scalably.

By this way, in compressing high-resolution VR video in which one sheet of input video is acquired through a variety of cameras, in base class, compression on original video may be performed, while in improvement class, one sheet of picture may be divided in regions as slice/tile and the like, by which encoding by each sub image may be performed.

At this time, the encoding apparatus 100 may process compression encoding through prediction method between classes (Inter-layer prediction) by which encoding efficiency is enhanced utilizing restored video of base class as reference video.

On the other hand, at the decoding apparatus 200, when specific video should be rapidly decoded according to user's motion with decoding base class, by decoding partial region of improvement class, a partial video decoding according to user motion can be rapidly performed.

As described above, in scalable compression way, the encoding apparatus 100 may encode base class, and in base class, scale down or down sampling or the like of voluntary rate on original video may be performed to compress. At this time, at improvement class, through scale up or up sampling or the like on restored video of base class, size of video is adjusted into the same resolution, and by utilizing restored video of base class corresponding to this as reference picture, encoding/decoding may be performed.

According to processing structure supporting scalability like above, the decoding apparatus 200 may decode entire bitstream of base class compressed at low bit or low resolution, and according to user's motion, can decode only a portion of video among the whole bitstream at improvement class. And, since decoding for entire video may not be performed as a whole, VR video may be able to be restored at only low complexity.

And, according to video compression way supporting separate scalability of different resolution, the encoding apparatus 100 may perform encoding based on prediction way between classes, in which, at base class, compression for original video or for video according to intention of video producer may be performed, while at improvement class, encoding is performed with reference to restored video of base class.

At this time, input video of improvement class may be a video encoded as a plurality of regions by dividing one sheet of input video through video division method. One divided region may include maximum one sub image, and a plurality of division regions may be configured with one sub image. Compressed bitstream encoded through division method like such can process two or more outputs at service and application step. For example, at service, the whole video is restored and output is performed through decoding for base class, and at improvement class, user's motion, perspective change and manipulation and the like are reflected through service or application, by which only a portion of region and a portion of sub image can be decoded.

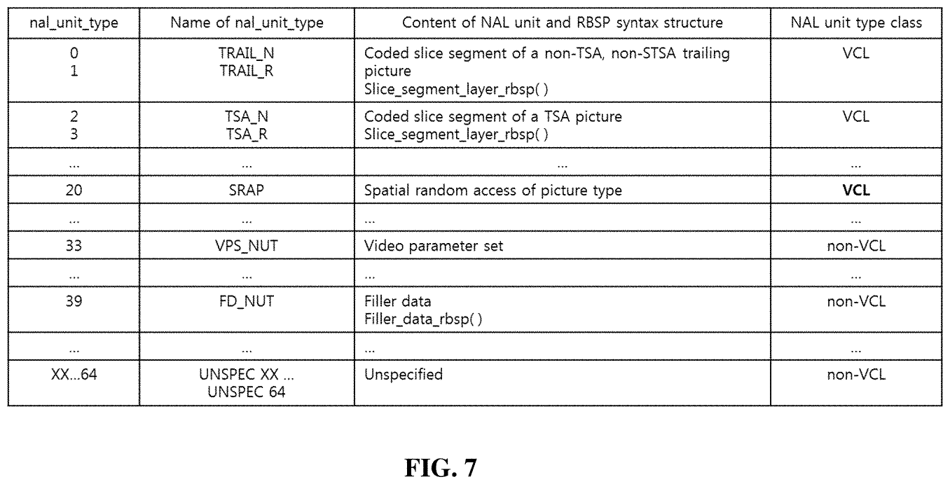

FIG. 7 to FIG. 9 are tables for explanation of signaling method of spatial layout information according to a variety of embodiments of the present invention.

As shown in FIG. 7 to FIG. 9, in general video encoding, spatial layout information may be signaled as one class type of NAL (NETWORK ABSTRACTION LAYER) UNIT format on HLS such as SPS (SEQUENCE PARAMETER SET) or VPS (VIDEO PARAMETER SET) defined as encoding parameter.

Firstly, FIG. 7 shows NAL UNIT type in which synchronized video encoding flag according to an embodiment of the present invention is inserted, and for example, synchronized video encoding flag according to an embodiment of the present invention may be inserted to VPS (VIDEO PARAMETER SET) or the like.

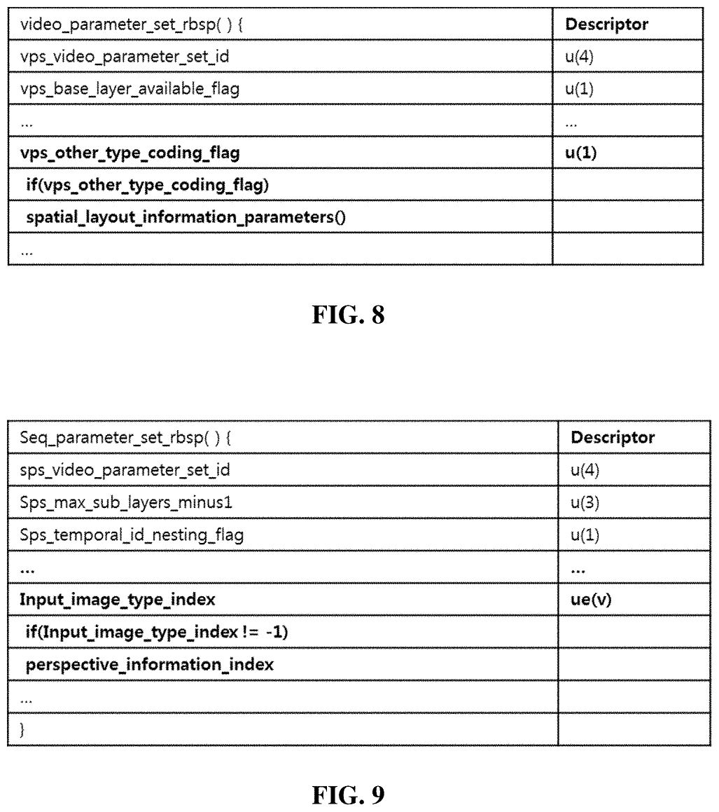

Accordingly, FIG. 8 shows an embodiment in which spatial layout information flag according to an embodiment of the present invention is inserted into VPS (VIDEO PARAMETER SET).

As shown in FIG. 8, the spatial layout information signaling unit 130 according to an embodiment of the present invention may insert flag for kind verification of separate input video onto VPS. The encoding apparatus 100 may insert flag showing that synchronized multi-view video encoding like VR contents is performed and spatial layout information is signaled, using vps_other_type_coding_flag through the spatial layout information signaling unit 130.

And, as shown in FIG. 9, the spatial layout information signaling unit 130 according to an embodiment of the present invention can signal that it is multi-view synchronized video encoded video onto SPS (SEQUENCE PARAMETER SET).

For example, as shown in FIG. 9, the spatial layout information signaling unit 130 may insert type (INPUT_IMAGE_TYPE) of input video, by which index information of synchronized multi-view video can be transmitted with being included in SPS.

Here, in case that INPUT_IMAGE_TYPE_INDEX on SPS is not −1, in case that INDEX value is −1, or in case that value thereof is designated as 0 to be corresponding to −1 in meaning, it can be shown that INPUT_IMAGE_TYPE is synchronized multi-view video according to an embodiment of the present invention.

And, in case that type of input video is synchronized multi-view video, the spatial layout information signaling unit 130 may signal perspective information thereof with being included in SPS, by which a portion of spatial layout information of synchronized multi-view video may be transmitted with being inserted in SPS. The perspective information is an information in which image layout by time zone is signaled according to 3D rendering processing process of 2D video, wherein order information such as upper end, lower end, and aspect may be included.

Accordingly, the decoding apparatus 200 may decode the flag of VPS or SPS to identify whether the video performed encoding using spatial layout information according to an embodiment of the present invention or not. For example, in case of VPS of FIG. 5, VPS_OTHER_TYPE_CODING_FLAG is extracted to be verified whether the video is synchronization multi-view video encoded using spatial layout information.

And, in case of SPS in FIG. 9, by decoding PERSPECTIVE_INFORMATION_INDEX information, practical spatial layout information like layout can be identified.

At this time, spatial layout information may be configured as format of parameter, and for example, spatial layout parameter information may be included in different way each other on HLS such as SPS, and VPS, may be configured syntax thereof as form such as separate function, or may be defined as SEI message.

And, according to an embodiment, spatial layout information may be transmitted with being included in PPS (PICTURE PARAMETER SET). In this case, property information by each sub image may be included. For example, independency of sub image may be signaled. The independency may show that the video can be encoded and decoded without reference to other video, and sub images of synchronized multi-view video may include INDEPENDENT sub image and DEPENDENT sub image. The dependent sub image may be decoded with reference to independent sub image. The spatial layout information signaling unit 130 may signal independent sub image onto PPS in a form of list (Independent sub image list).

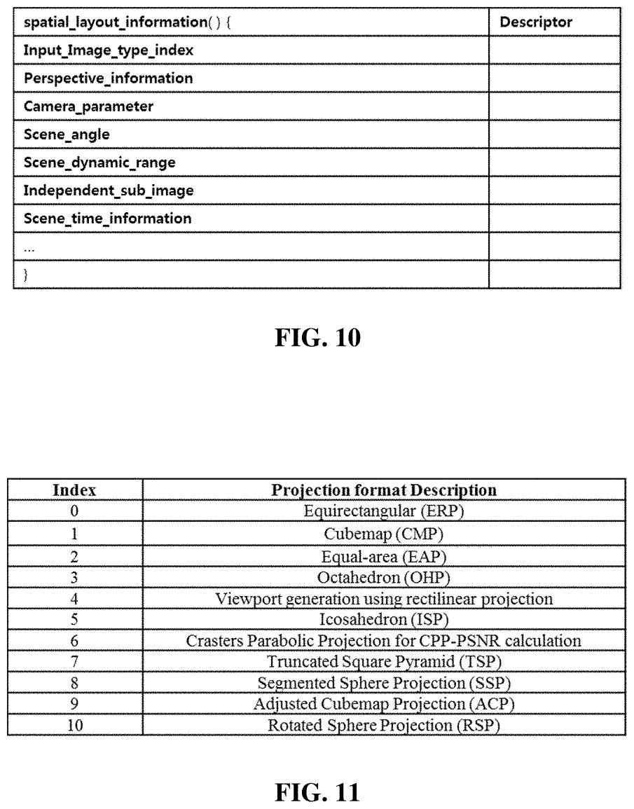

And, the spatial layout information may be signaled with being defined as SEI message. FIG. 10 illustrates SEI message as spatial layout information, and spatial layout information parameterized using spatial layout information descriptor may be inserted.

As shown in FIG. 10, spatial layout information may include at least one of type index information (input image type index), perspective information, camera parameter information, scene angle information, scene dynamic range information, independent sub image information, scene time information which can show spatial layout of input video, and additionally, a variety of information needed to efficiently encode multi-view synchronized video may be added. Parameters like such may be defined as SEI message format of one descriptor form, and, the decoding apparatus 200 may parse it to be able to use the spatial layout information efficiently at decoding, post-processing and rendering steps.

And, as described above, spatial layout information may be delivered to the decoding apparatus 200 in a format of SEI or meta-data.

And, for example, spatial layout information may be signaled by selection option like configuration at encoding step.

As a first option, spatial layout information may be included in VPS/SPS/PPS on HLS or coding unit syntax according to encoding efficiency on syntax.

As a second option, spatial layout information may be signaled at once as meta-data of SEI form on syntax.

Hereinafter, with reference to FIG. 11 to FIG. 19, efficient video encoding and decoding method according to synchronized multi-view video format according to an embodiment of the present invention may be described in detail.

As described above, a plurality of videos by view point generated at pre-processing step may be synthesized in one input video to be encoded. In this case, one input video may include a plurality of sub images. Each of sub images may be synchronized at the same point of time, and each may be corresponding to different view, visual perspective or scene. This may have effect of supporting a variety of view at the same POC (PICTURE ORDER COUNT) without using separate depth information like in prior art, and region overlapped between each sub images may be limited to boundary region.

Especially, spatial layout information of input video may be signaled in a form as described above, and the encoding apparatus 100 and decoding apparatus 200 can parse spatial layout information to use it in performing efficient encoding and decoding. That is, the encoding apparatus 100 may process multi-view video encoding using the spatial layout information at encoding step, while the decoding apparatus 200 may process decoding using the spatial layout information at decoding, pre-processing and rendering steps.

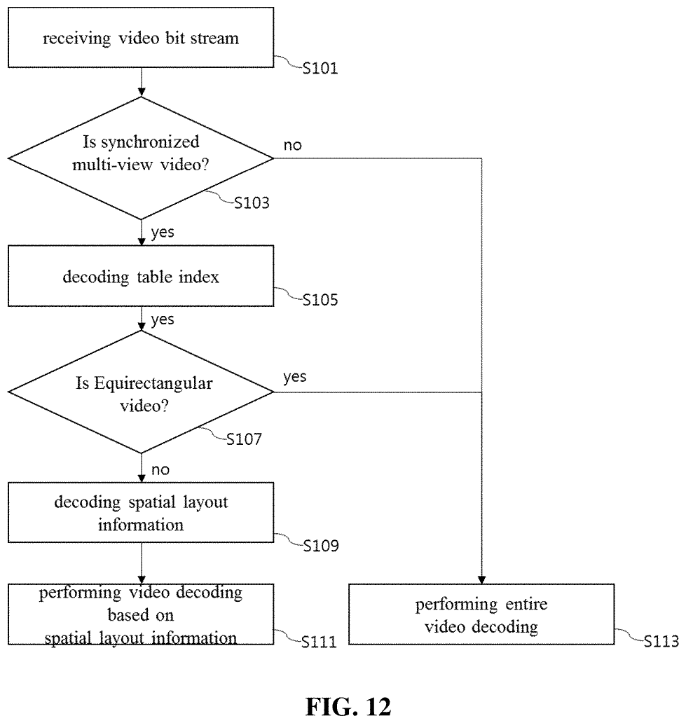

FIG. 11 and FIG. 12 are diagrams for explanation of type index table of spatial layout information according to an embodiment of the present invention.

As described above, sub images of input video may be arranged in a variety of ways. Accordingly, spatial layout information may include separately table index for signaling arrangement information. For example, as shown in FIG. 11, synchronized multi-view video may be illustrated with layout of Equirectangular (ERP), Cubemap (CMP), Equal-region (EAP), Octahedron (OHP), Viewport generation using rectilinear projection, Icosahedron (ISP), Crasters Parabolic Projection for CPP-PSNR calculation, Truncated Square Pyramid (TSP), Segmented Sphere Projection (SSP), Adjusted Cubemap Projection (ACP), Rotated Sphere Projection (RSP) and so on according to transform method, and table index shown in FIG. 12 corresponding to each layout may be inserted.

More specifically, according to each spatial layout information, three-dimensional video of coordinate system corresponding to 360 degrees may be processed with projection to two-dimensional video.

ERP is to perform projection transform of 360 degrees video to one face, and may include processing of u, v coordinate system position transform corresponding to sampling position of two-dimensional image and coordinate transform of longitude and latitude on sphere corresponding to the u, v coordinate system position. Accordingly, spatial layout information may include ERP index and single face information (for example, face index is set to 0).

CMP is to perform projection of 360 degrees video to six cubic faces, and may be arranged with sub images projected to each face index f corresponding to PX, PY, PZ, NX, NY, NZ (P denotes positive, and N, negative). For example, in case of CMP video, video in which ERP video is converted to 3×2 cubemap video may be included.

Accordingly, in spatial layout information, CMP index and each face index information corresponding to sub image may be included. The post-processing apparatus 20 may process two-dimensional position information on sub image according to face index, and may produce position information corresponding to three-dimensional coordinate system, and may output reverse transform into three-dimensional 360 degrees video according to the above.

ACP is to apply function adjusted to fit to three-dimensional bending deformation corresponding to each of projection transform to two-dimensional and reverse transform to three-dimensional, in projecting 360 degrees video to six cubic faces as in CMP, wherein processing function thereof is different, though used spatial layout information may include ACP index and face index information by sub image. Therefore, post-processing apparatus 20 may process reverse transform of two-dimensional position information on sub image according to face index through adjusted function to produce position information corresponding to three-dimensional coordinate system, and can output it as three-dimensional 360 degrees video according to above.

EAP is transform projected to one face like ERP, and may include longitude and latitude coordinate convert processing on sphere immediately corresponding to sampling position of two-dimensional image. The spatial layout information may include EAP index and single face information.

OHP is to perform projection of 360 degrees video to eight octahedron faces using six vertices, and sub images projected using faces {F0, F1, F2, F3, F4, F5, F6, F7} and vertices (V0, V1, V2, V3, V3, V4, V5) may be arranged in converted video.

Accordingly, at spatial layout information, OHP index, each face index information corresponding to sub image, and one or more vertex index information matched to the face index information may be included. And, sub image arrangement of converted video may be divided into compact case and not compact case. Accordingly, spatial layout information may further include compact-or-not identification information. For example, face index and vertex index matching information and reverse transform process may be determined differently for case of not compact and case of compact. For example, at face index 4, vertex index V0, V5, V1 may be matched in case of not being compact, while another matching of V1, V0, V5 may be processed in case of being compact.

The post-processing apparatus 20 may process reverse transform of two-dimensional position information on sub image according to face index and vertex index to produce vector information corresponding to three-dimensional coordinate system, by which reverse transform to three-dimensional 360 degrees video can be output according to above.

ISP is to project 360 degrees video using 20 faces and 12 vertices, wherein sub images according to each transform may be arranged in converted video. The spatial layout information may include at least one of ISP index, face index, vertex index, and compact identification information similarly to OHP.

SSP is to process with dividing sphere body of 360 degrees video into three segments of the north pole, the equator and the south pole, wherein the north pole and the south pole may be mapped to two circles identified by index respectively, edge between two polar segments may be processed with gray inactive sample, and the same projection method as that of ERP may be used to the equator. Accordingly, spatial layout information may include SSP index and face index corresponding to each the equator, the north pole and the south pole segment.

RSP may include way in which sphere body of 360 degrees video is divided into two same-sized divisions, and then the divided videos are expanded in two-dimensional converted video, to be arranged at two rows. And, RSP can realize the arrangement using six faces as 3×2 aspect ratio similar to CMP. Accordingly, a first division video of upper end segment and a second division video of lower end segment may be included in converted video. At least one of RSP index, division video index and face index may be included in the spatial layout information.

TSP may include a method of deformation projection of frame in which 360 degrees video is projected to six cubic faces corresponding to face of Truncated Square Pyramid. Accordingly, size and form of sub image corresponding to each face may be all different. At least one of TSP identification information and face index may be included in spatial layout information.

Viewport generation using rectilinear projection is to convert 360 degrees video and acquire two-dimensional video projected by setting viewing angle as Z axis, and spatial layout information may further include viewport generation using rectilinear projection index information and viewport information showing view point.

On the other hand, spatial layout information may further include interpolation filter information to be applied in the video transform. For example, interpolation filter information may be different according to each projection transform way, and at least one of nearest neighbor filter, Bi-Linear filter, Bi-Cubic filter, and Lanczos filter may be included.

On the other hand, transform way and index thereof for evaluation of processing performance of pre-processing transform and post-processing reverse transform may be defined separately. For example, performance evaluation may be used to determine pre-processing method at pre-processing apparatus 10, and as a method therefor, CP method converting two different converted videos to CPP (Crasters Parablic Projection) domain to measure PSNR may be illustrated.

It should be noted that, table shown in FIG. 12 is arranged randomly according to input video, which can be changed according to encoding efficiency and contents distribution of market and the like.

Accordingly, the decoding apparatus 200 may parse table index signaled separately to use it in decoding processing.

Especially, in an embodiment of the present invention, each layout information can be used helpfully in partial decoding of video. That is, sub image arrangement information such as cubic layout may be used in dividing independent sub image and dependent sub image, and accordingly, can be also used in determining efficient encoding and decoding scanning order, or in performing partial decoding on specific view point.

FIG. 12 is a flow chart for explanation of decoding method according to an embodiment of the present invention.

Referring to FIG. 12, first, the decoding apparatus 200 receives video bitstream (S101).

And, the decoding apparatus 200 verifies whether video is synchronized multi-view video or not (S103).

Here, decoding apparatus 200 can identify whether it is synchronized multi-view video from flag signaled from the spatial layout information signaling unit 130 from video bitstream. For example, the decoding apparatus 200 can identify whether video is synchronized multi-view video from VPS, SPS, and the like as described above.

In case of not being synchronized multi-view video, general overall video decoding is performed (S113).

And, in case of being synchronized multi-view video, the decoding apparatus 200 decodes table index from spatial layout information (S105).

Here, the decoding apparatus 200 can identify whether equirectangular video or not from table index (S107).

This is because, in case of equirectangular video from synchronized multi-view video, it may not be divided in separate sub image, and the decoding apparatus 200 perform decoding of the whole video for equirectangular video (S113).

In case of not being equirectangular video, the decoding apparatus 200 decodes rest of the whole spatial layout information (S109), and performs video decoding processing based on the spatial layout information (S111).

Here, the video decoding processing based on the spatial layout information may further include illumination compensation processing of the illumination compensation processing unit 145 using an illumination compensation parameter for neighboring regions.

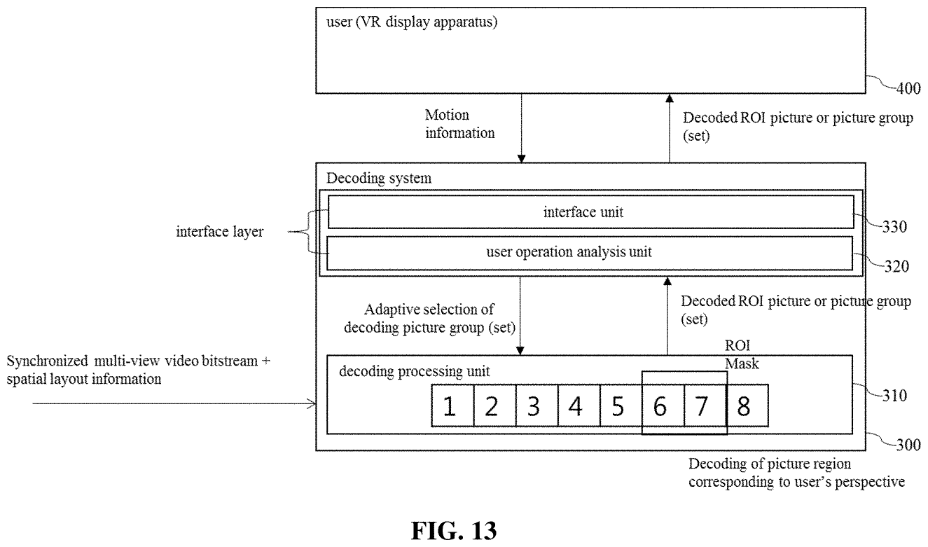

FIG. 13 is a diagram showing decoding system and operation thereof according to an embodiment of the present invention.

Referring to FIG. 13, a decoding system 300 according to an embodiment of the present invention may configure client system receiving the whole synchronized multi-view video bitstream and spatial layout information from encoding apparatus 100 described above, external server or the like and providing one or more decoded picture to user's virtual reality display apparatus 400.

For this, decoding system 300 may include decoding processing unit 310, user operation analysing unit 320 and interface unit 330. Though the decoding system 300 is described as separate system in this specification, this can be configured by combination of the whole or a portion of module configuring above-said decoding apparatus 200 and post-processing apparatus 20 for performing needed decoding processing and post-processing, or can be configured by extending the decoding apparatus 200. Therefore, it is not limited by designation thereof.

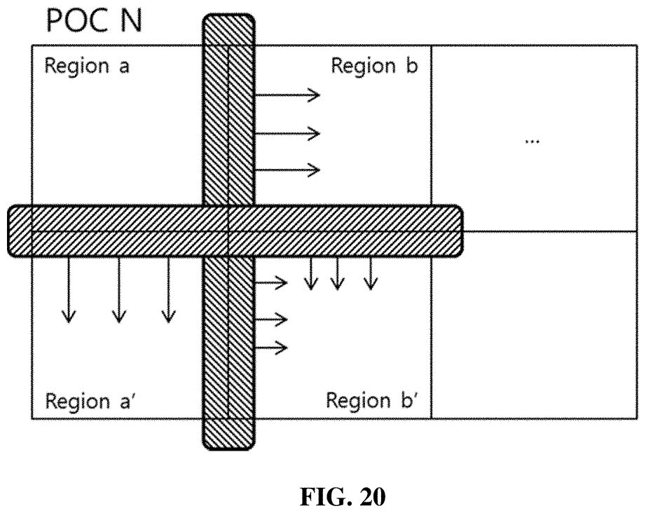

Accordingly, the decoding system 300 according to an embodiment of the present invention may perform selective decoding for a portion from the whole bitstream, based on spatial layout information received from the encoding apparatus 100 and user perspective information according to user operation analysis. Especially, according to selective decoding described in FIG. 20, the decoding system 300 may make correspondence of input videos having a plurality of view points of the same time (POC, Picture of Count) to user's view point by a direction, using spatial layout information. And, partial decoding for pictures of interested region (ROI, Region Of Interest) determined by user perspective by above may be performed.

As described above, the decoding system 300 can process selectively decoding corresponding to specific region selected using spatial layout information. For example, by decoding processed individually according to structure information, quality parameter (Qp) value corresponding to specific selected region is determined, and selective decoding according this can be processed. Especially, in selective decoding for the interested region (ROI), value of the quality parameter may be determined differently from that of other region. According to user's perspective, quality parameter for detailed region which is a portion of the ROI region may be determined differently from that of other region.

For the above, interface layer for receiving and analysing user information may be included at the decoding system 300, and mapping of view point supported by video currently being decoded and view point of the VR display apparatus 400, post-processing, rendering and the like may be selectively performed. More specifically, interface layer may include one or more processing modules for post-processing and rendering, the interface unit 330 and the user operation analysing unit 320.

The interface unit 330 may receive motion information from the VR display apparatus 400 worn by user.

The interface unit 330 may include one or more data communication module for receiving through wire or wireles sly signal of at least one of, for example, environment sensor, proximity sensor, operation sensing sensor, position sensor, gyroscope sensor, acceleration sensor, and geomagnetic sensor of user's VR display apparatus 400.

And, the user operation analysing unit 320 may analyse user operation information received from the interface unit 330 to determine user's perspective, and may deliver selection information for selecting adaptively decoding picture group corresponding to above to the decoding processing unit 310.

Accordingly, the decoding processing unit 310 may set ROI mask for selecting ROI (Region Of Interest) picture based on selection information delivered from the user operation analysing unit 320, and can decode only picture region corresponding to set ROI mask. For example, picture group may be corresponding to at least one of a plurality of sub images in above-said video frame, or reference images.

For example, as shown in FIG. 13, in case that sub images of specific POC decoded at the decoding processing unit 310 exist from 1 to 8, the decoding processing unit 310 may process decoding of only 6 and 7 of sub image region corresponding to user's visual perspective, which can improve processing speed and efficiency at real time.

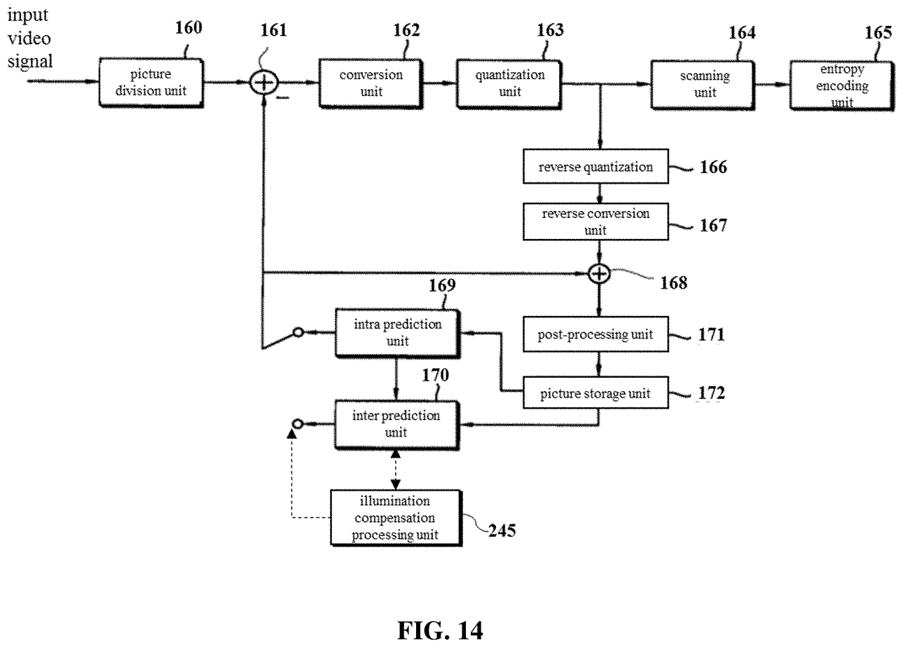

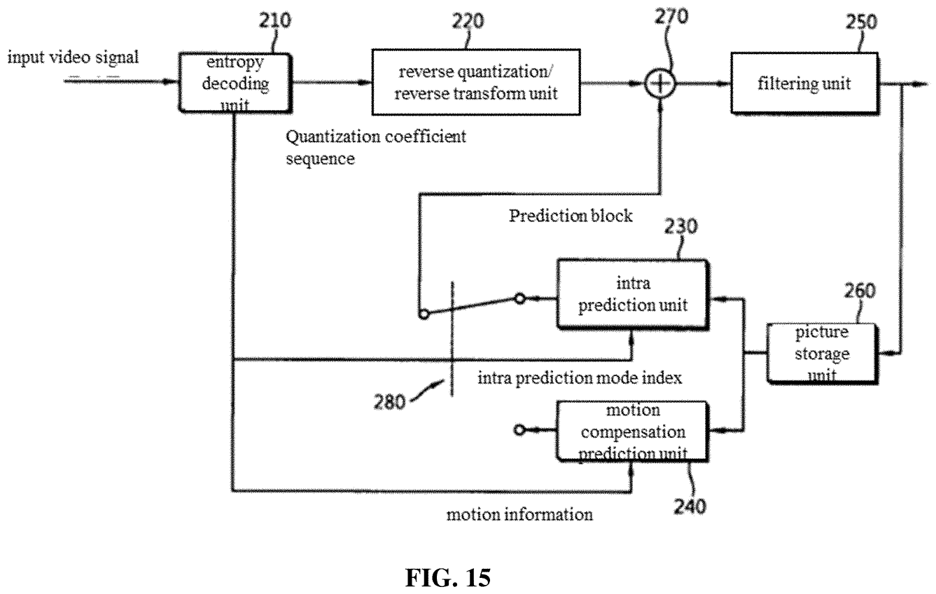

FIG. 14 and FIG. 15 are diagrams for explanation of encoding and decoding processing according to an embodiment of the present invention.

FIG. 14 shows configuration of video encoding apparatus according to an embodiment of the present invention as a block diagram, which may receive each sub image or entire frame of synchronized multi-view video according to an embodiment of the present invention as an input video signal to process.

Referring to FIG. 14, the video encoding apparatus 100 according to the present invention may include picture division unit 160, transform unit, quantization unit, scanning unit, entropy encoding unit, intra prediction unit 169, inter prediction unit170, reverse quantization unit, reverse transform unit, post-processing unit 171, picture storage unit 172, subtraction unit and addition unit 168.

The picture division unit 160 may analyse video signal input to divide picture into coding unit of predetermined size by largest coding unit (LCU) and determine prediction mode and size of prediction unit by the coding unit.

And, the picture division unit 160 may send prediction unit to be encoded to the intra prediction unit 169 or inter prediction unit170 according to prediction mode (or prediction method). And, the picture division unit 160 may send prediction unit to be encoded to subtraction unit.

The picture may be configured with a plurality of slices, and the slice may be configured with a plurality of largest encoding unit (Largest coding unit: LCU).

The LCU may be divided into a plurality of encoding unit (CU), encoder may add information (flag) showing whether being divided to bitstream. Decoder may recognize position of LCU using address (LcuAddr).

In case that division is not allowed, encoding unit (CU) is considered as prediction unit (PU), and decoder may recognize position of PU using PU index.

The prediction unit (PU) may be divided into a plurality of partitions. And prediction unit (PU) may be configured with a plurality of transformation unit (TU).

In this case, the picture division unit 160 may send video data to subtraction unit by block unit (for example, PU unit or TU unit) of predetermined size according to determined encoding mode.

CTB (Coding Tree Block) is used as video encoding unit, and at this time, CTB is defined as shape of a variety of square. CTB is called as coding unit (CU).

The coding unit (CU) may have form of quad tree according to division. And, in case of QTBT (Quad tree plus binary tree) division, coding unit may have form of the quad tree or binary tree binary divided from terminal node, and may be configured with maximum size of from 256×256 to 64×64 according to standard of encoder.

In addition, for more precise and efficient encoding and decoding, the encoding apparatus 100 according to an embodiment of the present invention may divide the coding unit as a ternary tree or triple tree structure, which can easily divide an edge area or the like of the coding unit divided to be long in a specific direction, by the quad tree or binary tree division.

Here, division of the ternary tree structure may be processed for all coding units without being specially limited. However, allowing the ternary tree structure only for a coding unit of a specific condition may be desirable considering the encoding and decoding efficiency as described above.

In addition, although the ternary tree structure may need ternary division of various methods for a coding tree unit, allowing only a predetermined optimized form may be desirable considering encoding and decoding complexity and transmission bandwidth of signaling.

Therefore, in determining division of the current coding unit, the picture division unit 160 may decide and determine whether or not to divide in a ternary tree structure of a specific form only when the current coding unit corresponds to a preset condition. In addition, as the ternary tree is allowed like this, the division ratio of a binary tree may be extended or changed to 3:1, 1:3 or the like, as well as 1:1. Therefore, the division structure of a coding unit according to an embodiment of the present invention may include a complex tree structure subdivided into quad trees, binary trees or ternary trees according to the ratio.

According to an embodiment of the present invention, the picture division unit 160 may perform complex division processing of processing quad tree division corresponding to a maximum size (e.g., pixel-based 128×128, 256×256 or the like) of a block, and processing at least one of the binary tree structure and the ternary tree structure corresponding to a terminal node divided into quad trees.

Especially, according to an embodiment of the present invention, the picture division unit 160 may determine any one division structure among a first binary division (BINARY 1) and a second binary division (BINARY 2), which are binary tree divisions, and a first ternary division (TRI 1) and a second ternary division (TRI 2), which are ternary tree divisions, corresponding to the characteristic and size of the current block, on the basis of a division table.

Here, the first binary division may correspond to vertical or horizontal division having a ratio of N:N, the second binary division may correspond to vertical or horizontal division having a ratio of 3N:N or N:3N, and each binary-divided root CU may be divided into CU0 or CU1 of each size specified in the division table.

On the other hand, the first ternary division may correspond to vertical or horizontal division having a ratio of N:2N:N, the second ternary division may correspond to vertical or horizontal division having a ratio of N:6N:N, and each ternary-divided root CU may be divided into CU0, CU1 or CU2 of each size specified in the division table.

For example, the picture division unit 160 may have depth of 0 when largest coding unit (LCU) in case of maximum size of 64×64, and may perform encoding by searching optimal prediction unit recursively till depth become 3, or till coding unit (CU) of 8×8 size. And, for example, for coding unit of terminal node divided as QTBT, PU (Prediction Unit) and TU (transformation unit) may have the same form as or more divided form than coding unit divided above.

The prediction unit for performing prediction may be defined as PU (Prediction Unit), and for each coding unit (CU), prediction of unit divided as a plurality of blocks may be performed. Prediction is performed with being divided into forms of square and rectangle.

The transform unit may convert residual block which is residual signal of original block of input prediction unit and prediction block generated from intra prediction unit 169 or inter prediction unit 170. The residual block may be configured with coding unit or prediction unit. The residual block configured with coding unit or prediction unit may be divided and converted to optimal transformation unit. Different transform matrix may be determined according to prediction mode (intra or inter). And, since residual signal of intra prediction may have directionality according to intra prediction mode, transform matrix may be determined adaptively according to intra prediction mode.

The transformation unit may be converted by two (horizontal, vertical) one-dimensional transform matrix. For example, in case of inter prediction, predetermined one transform matrix may be determined.

On the other hand, in case of intra prediction, since possibility that residual block may have directionality to vertical direction becomes higher in case tha intra prediction mode is horizontal, integer matrix based on DCT may be applied in vertical direction, while integer matrix based on DST or KLT may be applied in horizontal direction. In case that intra prediction mode is vertical, integer matrix based on DST or KLT may be applied in vertical direction, while integer matrix based on DCT, in horizontal direction.

In case of DC mode, integer matrix based on DCT may be applied in both directions. And, in case of intra prediction, depending on size of transformation unit, transform matrix may be determined adaptively.

The quantization unit may determine quantization step size for quantization of coefficients of residual block converted by the transform matrix. The quantization step size may be determined by encoding unit of greater than or equal to predetermined size (hereinafter, called as quantization unit).

The predetermined size may be 8×8 or 16×16. And, coefficients of the transform block may be quantized using quantization matrix determined according to determined quantization step size and prediction mode.

The quantization unit may use quantization step size of quantization unit neighboring to current quantization unit as quantization step size predictor of current quantization unit.

The quantization unit may search in order of left quantization unit, upper quantization unit, and upper-left quantization unit of current quantization unit, and then use one or two effective quantization step size to generate quantization step size predictor of current quantization unit.

For example, effective first quantization step size searched in above order may be determined as quantization step size predictor. And, average value of effective two quantization step size searched in above order also may be determined as quantization step size predictor, and in case that only one is effective, that may be determined as quantization step size predictor.

When the quantization step size predictor is determined, disparity value between quantization step size of current encoding unit and the quantization step size predictor may be transmitted to entropy encoding unit.

On the other hand, there may be possibility that all of left coding unit, upper coding unit, and upper-left coding unit to current coding unit do not exist. On the contrary, coding unit may exist that exists prior on encoding order in largest coding unit.

Therefore, in quantization units neighboring to current coding unit and the largest coding unit, quantization step size of just prior quantization unit on encoding order may be candidate.

In this case, priority may be set in order of 1) left quantization unit to current coding unit, 2) upper quantization unit to current coding unit, 3) upper-left quantization unit to current coding unit, and 4) just prior quantization unit on encoding order. The order may be changed, and the upper-left quantization unit may be further omitted.

The quantized transform block may be provided to reverse quantization unit and scanning unit.

The scanning unit may scan coefficients of quantized transform block to convert to one-dimensional quantization coefficients. Since coefficient distribution of transform block after quantization may be dependent on intra prediction mode, scanning way may be determined according to intra prediction mode.

And, coefficient scanning way may also be determined differently according to size of transformation unit. The scan pattern may become different according to directionality intra prediction mode. The scan order of quantization coefficients may be set as being scanned in reverse direction.

In case that the quantization coefficients are divided into a plurality of subsets, the same scan pattern may be applied to quantization coefficient in each subset. As scan pattern between subsets, zigzag scan or diagonal scan may be applied. As scan pattern, scanning from main subset including DC to rest subsets in forward direction is desirable, though reverse direction thereof is possible.

And, scan pattern between subsets may be set as the same as scan pattern of quantized coefficients in subset. In this case, scan pattern between subsets may be determined according to intra prediction mode. On the other hand, encoder may transmit information showing position of last non-zero quantization coefficient in the transformation unit to decoder.

Information showing position of last non-zero quantization coefficient in each subset may be also transmitted to decoder.

Reverse quantization 135 may reverse quantize the quantized quantization coefficient. The reverse transform unit may restore reverse quantized convert coefficient to residual block of space region. Adder may generate restoration block by adding residual block restored by the reverse transform unit and prediction block received from intra prediction unit 169 or inter prediction unit 170.

The post-processing unit 171 may perform filtering process for removal of blocking effect occurred in restored picture, adaptive offset application process for complement of difference value from original video by pixel unit, and adaptive loop filtering process for complement of difference value from original video by coding unit.

The filtering process is desirable to be applied to boundary of prediction unit and transformation unit having size greater than or equal to predetermined size. The size may be 8x8.

The filtering process may include step for determining boundary for filtering, step for determining boundary filtering strength to be applied to the boundary, step for determining whether to apply deblocking filter or not, and step for selecting filter to be applied to the boundary in case that the deblocking filter is determined to be applied.

Whether the deblocking filter is applied or not is determined by i) whether the boundary filtering strength is greater than 0, and ii) whether value showing change degree of pixel values at boundary portion of two blocks (P block, Q block) neighboring to the boundary to be filtered is less than first reference value determined by quantization parameter.

It is desirable that the filter is two or more. In case that absolute value of difference value between two pixels positioned at block boundary is greater than or equal to second reference value, filter performing relatively weak filtering may be selected.

The second reference value is determined by the quantization parameter and the boundary filtering strength.

The adaptive offset application process is to reduce difference value (distortion) between pixel in video to which deblocking filter is applied and original pixel. Whether the adaptive offset application process is performed or not may be set by picture or slice unit.

The picture or slice may be divided into a plurality of offset regions, and offset type may be determined by each offset region. The offset type may include edge offset type of predetermined number (for example, four) and two band offset type.

In case that offset type is edge offset type, edge type in which each pixel falls in may be determined, and offset corresponding to the same may be applied. The edge type may be determined by distribution of two pixel values neighboring to current pixel.

The adaptive loop filtering process may perform filtering based on value comparing video restored through deblocking filtering process or adaptive offset application process and original video. The adaptive loop filtering may be applied to entire pixels included in block of 4×4 size or 8×8 size of the determined ALF.

Whether adaptive loop filter is applied or not may be determined by coding unit. The size and coefficient of applied loop filter may become different according to each coding unit. Information showing whether the adaptive loop filter is applied or not by coding unit may be included in each slice header.

In case of chrominance signal, whether adaptive loop filter is applied or not may be determined by picture unit. The form of loop filter may also have rectangle form differently from case of brightness.

Whether adaptive loop filtering is applied or not may be determined by slice. Therefore, information showing whether adaptive loop filtering is applied or not to current slice may be included in slice header or picture header.

When it is shown that adaptive loop filtering is applied to current slice, slice header or picture header may include additively information showing filter length of horizontal and/or vertical direction of brightness component used in adaptive loop filtering process.

The slice header or picture header may include information showing the number of filter set. At this time, when the number of filter set is two or more, filter coefficients may be encoded using prediction method. Therefore, slice header or picture header may include information showing whether filter coefficients are encoded by prediction method, in case that prediction method is used, may include predicted filter coefficient.

On the other hand, not only brightness, but also chrominance components may be filtered adaptively. Therefore, slice header or picture header may include information showing whether each chrominance component is filtered. In this case, to reduce the number of bits, information showing whether filtering on Cr and Cb may be performed with joint coding (that is, multiplexing coding).

At this time, in case of chrominance components, since possibility that the case in which Cr and Cb are both not filtered is the most frequent may be high to reduce complexity, entropy encoding may be performed with allocating the smallest index to the case in which Cr and Cb are both not filtered.

And, with allocating the largest index to the case in which Cr and Cb are both filtered, entropy encoding may be performed.

The picture storage unit 172 may receive post-processed video data input from post-processing unit 171, and restore video with picture unit to store. The picture may be video of frame unit or video of field unit. The picture storage unit 172 may be equipped with buffer (not shown) capable of storing a plurality of pictures.

The inter prediction unit170 may perform motion presumption using at least one or more reference picture stored in the picture storage unit 172, and may determine reference picture index showing reference picture and motion vector.

And, according to determined reference picture index and motion vector, prediction block corresponding to prediction unit to be encoded may be extracted and output, from reference picture used in motion presumption from a plurality of reference pictures stored in picture storage unit 172.

Here, the inter prediction unit 170 may provide motion compensation prediction processing information to the illumination compensation processing unit 145 so that the prediction block, which is illumination-compensated for a neighboring region, may be processed, and the processing may include processing of applying the illumination compensation parameter on the prediction block or the block processed and restored according to reconfiguration or matching, as described above in FIG. 2.

The intra prediction unit 169 may perform intra prediction encoding using pixel value reconfigured in picture included in current prediction unit.

The intra prediction unit 169 may receive current prediction unit to be prediction encoded as input, and may select one from intra prediction modes of preset number according to size of current block to perform intra prediction.

The intra prediction unit 169 may perform filtering adaptively reference pixel to generate intra prediction block. In case that reference pixel is not available, reference pixels may be generated using available reference pixels.

The entropy encoding unit may perform entropy encoding of quantization coefficient quantized by quantization unit, intra prediction information received from the intra prediction unit 169, motion information received from the inter prediction unit 170, and the like.

Though not shown, the inter prediction encoding apparatus may be configured including motion information determination unit, motion information encoding mode determination unit, motion information encoding unit, prediction block generation unit, residual block generation unit, residual block encoding unit and multiplexer.

The motion information determination unit may determine motion information of current block. The motion information may include reference picture index and motion vector. The reference picture index may show any one of pictures restored with prior encoding.

In case that current block is single direction inter prediction encoded, any one of reference pictures belonged to list 0 (L0) may be shown. On the other hand, in case that current block is both directions prediction encoded, reference picture index showing one of reference pictures of list 0 (L0) and reference picture index showing one of reference pictures of list 1 (L1) may be included.

And, in case that current block is both directions prediction encoded, index showing one or two pictures of reference pictures of complex list (LC) generated by combining list 0 and list 1 may be included.

The motion vector may show position of prediction block in picture showing each reference picture index. The motion vector may be in pixel unit (integer unit), though may be also in sub pixel unit.

For example, it may have resolution of ½, ¼, ⅛ or 1/16 pixel. In case that motion vector is not in integer unit, prediction block may be generated from pixels of integer unit.

The motion information encoding mode determination unit may determine in which mode from skip mode, merge mode, and AMVP mode motion information of current block may be encoded.

The skip mode may be applied in case that there exist skip candidate having the same motion information as motion information of current block, and residual signal is 0. And, skip mode may be applied when current block is the same as coding unit in size. Current block may be considered as prediction unit.

The merge mode may be applied when there exist merge candidate having the same motion information as motion information of current block. The merge mode may be applied in case that current block is different from coding unit in size, or even though size is identical, in case that there exist residual signal. The merge candidate and skip candidate may be the same.

The AMVP mode may be applied when skip mode and merge mode is not applied. The AMVP candidate having the most similar motion vector to motion vector of current block may be selected as AMVP predictor.

The motion information encoding unit may encode motion information according to way determined by motion information encoding mode determination unit. In case that motion information encoding mode is skip mode or merge mode, merge motion vector encoding process may be performed. In case that motion information encoding mode is AMVP, AMVP encoding process may be performed.

The prediction block generation unit may generate prediction block using motion information of current block. In case that motion vector is integer unit, block corresponding to position shown by motion vector in picture shown by reference picture index, to generate prediction block of current block.

However, in case that motion vector is not integer unit, pixels of prediction block may be generated from integer unit pixels in picture shown by reference picture index.

In this case, in case of brightness pixel, prediction pixel may be generated using interpolation filter of eight taps. In case of chrominance pixel, prediction pixel may be generated using four tap interpolation filter.

The residual block generation unit may generate residual block using current block and prediction block of current block. In case that size of current block is 2N×2N, residual block may be generated using current block and prediction block of 2N×2N size corresponding to current block.

However, size of current block used in prediction is 2N×N or N×2N, prediction block for each of two 2N×N blocks configuring 2N×2N is acquired, and then final prediction block of 2N×2N size may be generated using above two 2N×N prediction blocks.

And, residual block of 2N×2N may be also generated using the prediction block of 2N×2N size. To settle discontinuity property of boundary portion of two prediction blocks of 2N×N size, overlap smoothing on pixels of boundary portion may be performed.

The residual block encoding unit may divide generated residual block into one or more transformation units. And, each transformation unit may be performed with convert encoding, quantization and entropy encoding. At this time, size of transformation unit may be determined in quad tree according to size of residual block.

The residual block encoding unit may convert residual block generated by inter prediction method using transform matrix of integer base. The transform matrix is DCT matrix of integer base.

The residual block encoding unit may use quantization matrix to quantize coefficients of residual block converted by the transform matrix. The quantization matrix may be determined by quantization parameter.

The quantization parameter may be determined by coding unit of greater than or equal to predetermined size. The predetermined size may be 8×8 or 16×16. Therefore, in case that current coding unit is smaller than the predetermined size, quantization parameter of only first coding unit on encoding order on plurality of coding unit in the predetermined size may be encoded. The quantization parameter of rest coding unit is the same as the parameter, and needs not encoding.

And, coefficients of the transform block may be quantized using quantization matrix determined according to determined quantization parameter and prediction mode.

The quantization parameter determined by coding unit of greater than or equal to the predetermined size may be prediction encoded using quantization parameter of coding unit neighboring to current coding unit. Left coding unit and upper coding unit of current coding unit are searched in order, and quantization parameter predictor of current coding unit may be generated using one or two effective quantization parameter.

For example, first effective quantization parameter searched in above order may be determined as quantization parameter predictor. And, first effective quantization parameter searched in order of left coding unit, just prior coding unit on encoding order may be determined as quantization parameter predictor.

The coefficients of quantized transform block may be scanned and converted to one-dimensional quantization coefficients. The way of scanning may be set differently according to entropy encoding mode. For example, in case of encoding in CABAC, inter prediction encoded quantization coefficients may be scanned in predetermined way (zigzag, or raster scan in diagonal direction). On the other hand, in case of encoding in CAVLC, it may be scanned in other way than above.

For example, in case that scanning way is inter, it is determined as zigzag, while in case of intra, it may be determined according to intra prediction mode. And, coefficient scanning way may be determined differently according to size of transformation unit.

The scan pattern may become different according to directionality intra prediction mode. The scan order of quantization coefficients may set as being scanned in reverse direction.

The multiplexer may multiplex motion informations encoded by the motion information encoding unit and residual signals encoded by the residual block encoding unit. The motion information may become different according to encoding mode.

That is, in case of skip or merge, only index showing prediction may be included. However, in case of AMVP, reference picture index, disparity motion vector and AMVP index of current block may be included.

Hereinafter, an embodiment for operation of intra prediction unit 169 will be described in detail.

First, prediction mode information and size of prediction block may be received by the picture division unit 160, and prediction mode information may show intra mode. The size of prediction block may be square of 64×64, 32×32, 16×16, 8×8, 4×4 and the like, but not limited as above. That is, size of the prediction block may be non-square which is not square.

Next, to determine intra prediction mode of prediction block, reference pixel may be read in from the picture storage unit 172.

Whether to generate reference pixel or not may be determined by reviewing whether unavailable reference pixel exist or not. The reference pixels may be used in determining intra prediction mode of current block.

In case that current block is positioned at upper boundary of current picture, pixels neighboring to upper of current block may not be defined. And, in case that current block is positioned at left boundary of current picture, pixels neighboring left of current block may not be defined.

These pixels are determined to be unavailable pixels. And, in case that current block is positioned at slice boundary, and pixels neighboring to upper or left of slice are not pixels being encoded and restored in priority, they are determined to be unavailable pixels.

As described above, in case that there do not exist pixels neighboring to left or upper of current block, or there do not exist pixels being encoded and restored in priority, intra prediction mode of current block may be determined using only available pixels.

However, reference pixels of unavailable position may be also generated using available reference pixels of current block. For example, in case that pixels of upper block is unavailable, upper pixels may be generated using a portion or the whole of left pixels, and vice versa.

That is, reference pixel may be generated by duplicating available reference pixel of nearest position in predetermined direction from reference pixel of unavailable position. In case that available reference pixel does not exist in predetermined direction, reference pixel may be generated by duplicating available reference pixel of nearest position in opposite direction.

On the other hand, even in case that upper or left pixels of current block exist, it may be determined as unavailable reference pixel according to encoding mode of block in which the pixel belongs to.

For example, block to which reference pixel neighboring to upper of current block is inter encoded and restored block, the pixels may be determined as unavailable pixels.

In this case, available reference pixels may be generated using pixels belonging to block in which block neighboring to current block is intra encoded and restored. In this case, information that available reference pixel is determined according to encoding mode may be transmitted from encoder to decoder.

Next, intra prediction mode of current block may be determined using the reference pixels. The number of intra prediction mode allowable to current block may become different according to size of block. For example, in case that size of current block is 8×8, 16×16, and 32×32, 34 intra prediction modes may exist, and in case that size of current block is 4×4, 17 intra prediction modes may exist.

Above 34 or 17 intra prediction modes may be configured with at least one or more non-directional modes and a plurality of directional modes.

One or more non-directional modes may be DC mode and/or planar mode. In case that DC mode and planar mode are included in non-directional mode, regardless of size of current block, 35 intra prediction modes may also exist.

At this time, two non-directional modes (DC mode and planar mode) and 33 directional modes may be included.

The planar mode may generate prediction block of current block using at least one pixel value positioned at bottom-right of current block (or prediction value of the pixel value, hereinafter called as first reference value) and reference pixels.

As described above, configuration of video decoding apparatus according to an embodiment of the present invention may be deduced from configuration of video encoding apparatus described with reference to FIG. 1, FIG. 2 and FIG. 25, and video may be decoded, for example, by performing reverse processing of encoding process as described with reference to FIG. 2 and FIG. 25.

FIG. 15 shows a block diagram of configuration of video decoding apparatus according to an embodiment of the present invention.

Referring to FIG. 15, video decoding apparatus according to the present invention is equipped with entropy decoding unit 210, reverse quantization/reverse transform unit 220, adder 270, filtering unit 250, picture storage unit 260, intra prediction unit 230, motion compensation prediction unit 240, illumination compensation processing unit 245 and intra/inter changing switch 280.

The entropy decoding unit 210 may decode encoded bitstream transmitted from video encoding apparatus, and may separate it into intra prediction mode index, motion information, quantization coefficient sequence and the like. The entropy decoding unit 210 may provide decoded motion information to motion compensation prediction unit 240.

The entropy decoding unit 210 may provide the intra prediction mode index to the intra prediction unit 230, and reverse quantization/reverse transform unit 220. And, the entropy decoding unit 210 may provide the reverse quantization coefficient sequence to reverse quantization/reverse transform unit 220.

The reverse quantization/reverse transform unit 220 may convert the quantization coefficient sequence to reverse quantization coefficient of two-dimensional arrangement. For above transform, one of a plurality of scanning patterns may be selected. One from a plurality of scanning patterns may be selected based on at least one of prediction mode of current block (that is, any one of intra prediction and inter prediction) and intra prediction mode.

The intra prediction mode may be received from intra prediction unit or entropy decoding unit.

The reverse quantization/reverse transform unit 220 may restore quantization coefficient using quantization matrix selected from a plurality of quantization matrix at reverse quantization coefficient of the two-dimensional arrangement. Different quantization matrix may be applied according to size of current block to be restored, and even for block of the same size, quantization matrix may be selected based on at least one of prediction mode and intra prediction mode of the current block.

And, residual block may be restored by reverse transform of restored quantization coefficient.

The adder 270 may restore video block by adding residual block restored by reverse quantization/reverse transform unit 220 and prediction block generated by intra prediction unit 230 or motion compensation prediction unit 240.

The filtering unit 250 may perform filter processing to restored video generated by adder 270. Accordingly, deblocking artefact caused by video loss according to quantization process may be reduced.

In addition, the filtering unit 250 may perform region adaptive and selective filtering corresponding to an inter-region boundary region according to an embodiment of the present invention.

The picture storage unit 260 may be frame memory maintaining local decoded video performed with filter processing by filtering unit 250.

The intra prediction unit 230 may restore intra prediction mode of current block based on intra prediction mode index received from entropy decoding unit 210. And, prediction block may be generated according to restored intra prediction mode.

The motion compensation prediction unit 240 may generate prediction block for current block from picture stored in picture storage unit 260 based on motion vector information. In case that motion compensation of decimal point precision is applied, prediction block may be generated by applying selected interpolation filter.

Here, the motion compensation prediction unit 240 may provide motion compensation prediction processing information to the illumination compensation processing unit 245 so that the prediction block, which is illumination-compensated for a neighboring region, may be processed, and the processing may include processing of applying the illumination compensation parameter on the prediction block or the block processed and restored according to reconfiguration or matching, as described above in FIG. 2.

The intra/inter changing switch 280 may provide prediction block generated from any one of intra prediction unit 230 and motion compensation prediction unit 240 based on encoding mode to adder 270.

Current block may be restored using prediction block of current block restored in such a way and residual block of decoded current block.

The video bitstream according to an embodiment of the present invention may be unit used in storing encoded data at one picture, and may include PS (parameter sets) and slice data.

The PS (parameter sets) may be divided into picture parameter set (hereinafter, simply referred as PPS) which is data corresponding to head of each picture, and sequence parameter set (hereinafter, simply referred as SPS). The PPS and SPS may include initializing information necessary for initializing each encoding, and spatial layout information according to an embodiment of the present invention may be included.

The SPS is common reference information for decoding all pictures encoded with random access unit (RAU), and may include profile, maximum number of available picture for reference, picture size, and the like.

The PPS is reference information for decoding picture for each picture encoded with random access unit (RAU), and may include kind of variable length encoding method, initial value of quantization step, and a plurality of reference pictures.

On the other hand, slice header (SH) may include information for the slice at the time of coding of slice unit.

In addition, whether the illumination compensation processing has been completed as described above can be signaled in the form of a flag and may be transmitted with being included in at least one of the VPS, SPS and PPS described above according to the video unit of previously defined illumination compensation processing.

In addition, the neighboring region information and the illumination compensation parameter may be included in the PPS, together with the spatial layout information. In addition, for example, initial neighboring region information may be transmitted with being included in header information corresponding to the first video unit (e.g., tile or slice) in a specific picture, and the neighboring region information may be derived from the initial neighboring region information.

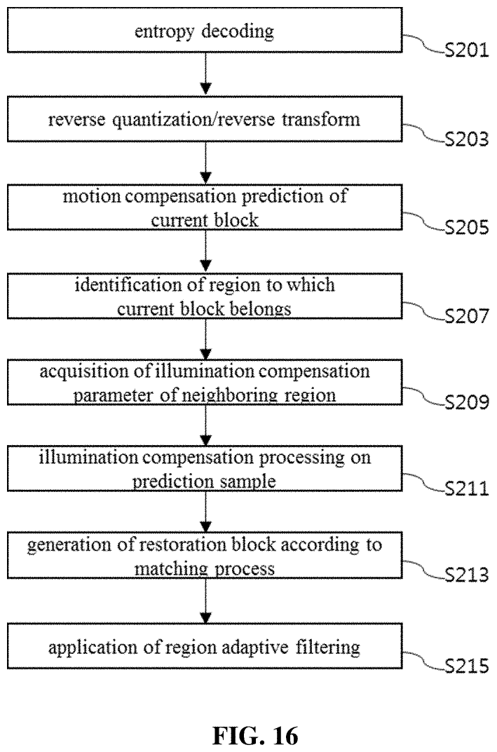

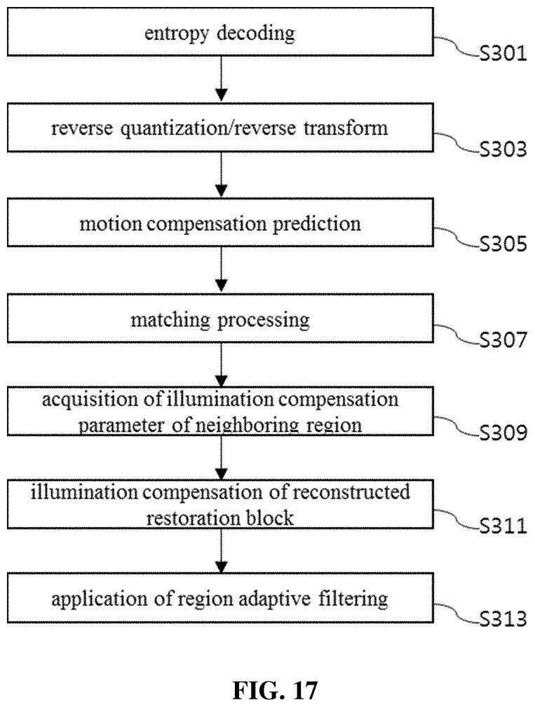

FIG. 16 and FIG. 17 are flow charts for explanation of a decoding method of processing illumination compensation based on region parameter according to an embodiment of the present invention.

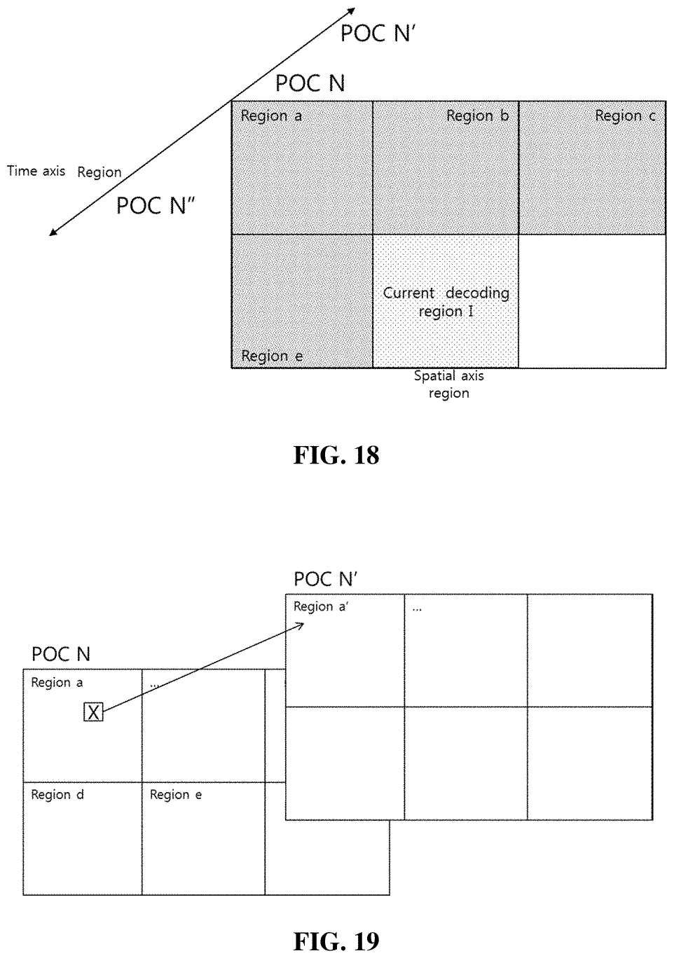

FIG. 18 is a diagram for explanation of a region area of a synchronized multi-view video and spatially neighboring regions according to an embodiment of the present invention, and FIG. 19 is a diagram for explanation of temporally neighboring regions according to an embodiment of the present invention.

First, as shown in FIG. 18 and FIG. 19, each sub image may be arranged in each perspective region corresponding to a picture by spatial merge or stitch processing. Accordingly, regions spatially merged and synchronized along the spatial axis may configure a picture, and a picture maybe arranged on time axis in order of time-series POC (Picture Order Count).

Accordingly, the plurality of regions may be temporally synchronized with and correspond to a plurality of face indexes configuring the current picture, and a neighboring reference region may be a region corresponding to another face index spatially adjacent on the current picture in correspondence to a region to which the current block belongs. For example, as shown in FIG. 18, a region neighboring on the spatial axis of the current region Ito which the current block of the N-th picture POC N belongs may be any one among a, b, c and e, which are regions decoded in advance.

In addition, the plurality of regions may be regions positioned at the same position as that of the current region in the pictures of different time zone. Accordingly, the neighboring reference region may be a region at the same position of a temporally neighboring picture corresponding to a picture to which the region of the current block belongs to. As shown in FIG. 19, a region neighboring on the time axis of the current Region a, to which the current block of POC N belongs, may correspond to Region a′ at the same position of POC N′ decoded in advance.

Therefore, a region may correspond to a plurality of block divisions in an arbitrary picture and may be defined by, for example, picture division method or structure, such as a slice or a tile, according to coding standards. According to exemplary definition, the minimum size of a region maybe defined as two or more CTUs, and the maximum size may correspond to a picture.

At this time, the division structure for region division may be defined and signaled in a separate syntax or signaled with being included in the syntax of a specific picture division unit such as a slice or a tile, according to standards. Here, the signaled information may include at least one of region division information and illumination compensation parameter information.

Accordingly, the illumination compensation processing unit 145 of the encoding apparatus 140 may determine a region spatially or temporally neighboring the current region, acquire an illumination compensation parameter of the determined region, perform illumination compensation processing for the current region using the illumination compensation parameter, generate signaling information according thereto, and deliver the signaling information to the decoding apparatus 200.

Accordingly, FIG. 16 is a flow chart illustrating a first embodiment of processing illumination compensation for a prediction sample by the decoding apparatus 200, and referring to FIG. 16, the decoding apparatus 200 performs entropy decoding on inputted bitstream through the entropy decoding unit 210 (S201), processes reverse quantization and reverse transform through the reverse quantization/reverse transform unit 220 (S203), and acquires a prediction sample by performing motion compensation prediction processing on the current block through the motion compensation prediction unit 240 (S205).

And, the decoding apparatus 200 may identify the current region, to which the current block belongs, through the illumination compensation processing unit 245 (S207), acquire illumination compensation parameters of a neighboring region corresponding to the current region (S209), acquire a prediction sample illumination-compensated for the prediction sample of the current block using the acquired illumination compensation parameters (S211), and deliver the prediction sample to the motion compensation prediction unit 240.

Here, the illumination compensation processing of the prediction sample may be processed by applying a linear expression of scale factor a, which is an illumination scale parameter, and an offset β, which is an illumination offset parameter, as illumination compensation parameters. For example, when Y is an illumination-compensated prediction sample, an operation such as Y=α*pic_values+βcan processed. Here, pic_values may include a value of the illumination-compensated prediction sample (predictor).

For this, the illumination compensation processing unit 245 may acquire neighboring region information or its initial information and illumination compensation parameters of the neighboring region from the signaling information received from the encoding apparatus 100 described above. For example, according to region, when a picture is divided into N in an arbitrary video, Region parameter (α, β), which is N illumination compensation parameters, may exist in each picture.

On the other hand, the motion compensation prediction unit 240 may generate a restoration block by matching blocks using the illumination-compensated prediction sample and a residual block provided by the reverse quantization/reverse transform unit 220 (S213). For example, the motion compensation prediction unit 240 may generate a restoration block by matching an illumination-compensated motion compensation prediction block and the residual block through an adder.

And, the decoding apparatus 200 may identify a neighboring region and a boundary region, confirm information on filter processing corresponding to the boundary region, adaptively process filter processing corresponding to the boundary region configured of the restored region (S215). This can be processed through the illumination compensation processing unit 245 or the filtering unit 250 and will be described in FIG. 20 in more detail.

On the other hand, FIG. 17 is a flow chart illustrating a second embodiment of processing illumination compensation for a prediction sample by the decoding apparatus 200, and referring to FIG. 17, the decoding apparatus 200 performs entropy decoding through the entropy decoding unit 210 of inputted bitstream (S301), processes reverse quantization and reverse transform through the reverse quantization/reverse transform unit 220 (S303), and performs motion compensation prediction processing on the current block through the motion compensation prediction unit 240 (S305).

And, the motion compensation prediction unit 240 may generate a restoration block by matching using the prediction sample and a residual block provided by the reverse quantization/reverse transform unit 220 (S307). For example, the motion compensation prediction unit 240 may generate a restoration block by matching an illumination-compensated motion compensation prediction block and the residual block through an adder.

And, the decoding apparatus 200 may identify the current region, to which the restored block belongs, through the illumination compensation processing unit 245, acquire illumination compensation parameters of a neighboring region corresponding to the current region (S309), perform illumination compensation processing on the restoration block using the acquired illumination compensation parameters (S311), and output the restoration block.

Here, the illumination compensation processing of the restoration block may be processed by applying a linear expression of scale factor a and offset β similarly to processing of prediction sample. For example, when Y is an illumination-compensated restoration block, an operation such as Y=α*pic_values+βcan processed. Here, pic_values may include a value of the restoration block reconstructed according to match processing.

For this, the illumination compensation processing unit 245 may acquire neighboring region information or its initial information for deriving the neighboring region information and illumination compensation parameters of the neighboring region from the signaling information from the encoding apparatus 100 described above. For example, according to region, when a picture is divided into N in an arbitrary video, Region parameter (α, β), which is N illumination compensation parameters, may exist for each picture.

And, the decoding apparatus 200 may identify a neighboring region and a boundary region, confirm information on filter processing corresponding to the boundary region, adaptively process the filter processing corresponding to the boundary region configured of the restored region (S215). This can be processed through the illumination compensation processing unit 245 or the filtering unit 250.

In the illumination compensation processing corresponding to FIG. 16 and FIG. 17 like this, the neighboring region may include at least one of a region neighboring on the spatial axis as shown in FIG. 18 and a region neighboring on the time axis as shown in FIG. 19, and the illumination compensation parameter may be acquired from one or more neighboring regions. This may be determined by the encoding apparatus 100 and signaled to the decoding apparatus 200.

In addition, when the illumination compensation processing corresponding to FIG. 16 and FIG. 17 is performed using the illumination compensation parameters of the spatially neighboring region, the decoding apparatus 200 may further perform additional LIC (Local Illumination Compensation) of a block unit.

In this case, after correction of some sparse brightness values is performed in the spatial unit, correction of more precise brightness values may be performed in the temporal unit.

Accordingly, in illumination compensation processing, the decoding apparatus 200 may first apply illumination compensation processing using spatially neighboring regions and perform Temporally Local illumination compensation processing for the illumination-compensated region.

FIG. 20 is a diagram for explanation of region adaptive filtering according to an embodiment of the present invention.

Referring to FIG. 20, according to an embodiment of the present invention, as is described at step S215 or S313, when a restoration block belongs to a boundary region between neighboring regions after the matching step, the decoding apparatus 200 may selectively perform boundary region filtering corresponding thereto, and On/Off information therefor may be signaled from the encoding apparatus 100 to the decoding apparatus 200.

Accordingly, in illumination compensation based on region, the decoding apparatus 200 according to an embodiment of the present invention may identify a region for illumination compensation and a boundary region between regions in advance and selectively perform filter processing corresponding to the boundary region through the filtering unit 250 or the illumination compensation processing unit 245.

In this case, the filter direction may be vertical or horizontal direction between regions, and filtering processes may be selectively applied only for the region boundary region.

In addition, it is also possible to apply the illumination compensation of the illumination compensation processing unit 245 described above only in the boundary region. Accordingly, the illumination compensation processing unit 245 may selectively perform illumination compensation processing as shown in FIG. 16 or FIG. 17 only when the current block is identified as an inter-region boundary region.

Accordingly, referring to FIG. 20, in the region boundary region of Region b, filter processing or illumination compensation processing in the horizontal direction may be selectively performed by the decoding apparatus 200 with reference to Region a decoded in advance.

In addition, in Region a′, filter processing or illumination compensation processing in the vertical direction may be selectively performed by the decoding apparatus 200 with reference to the value of Region a decoded in advance.

On the other hand, in Region b′, filter processing or illumination compensation processing in at least one of the vertical direction and the horizontal direction may be selectively performed with reference to Region b and Region a′ decoded in advance.

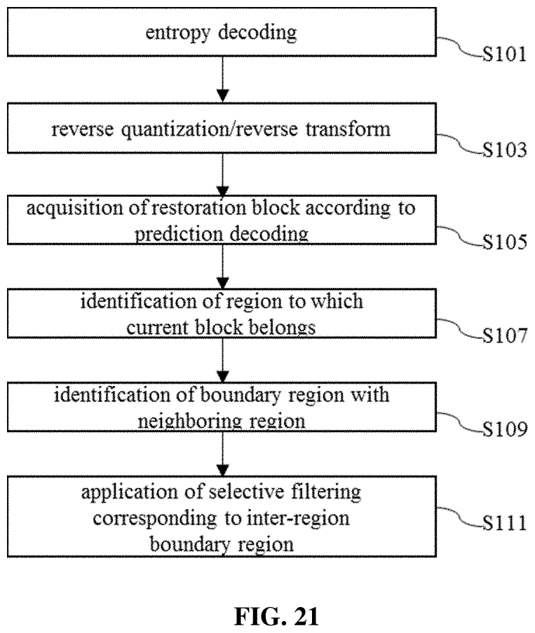

FIG. 21 is a flow chart for explanation of a decoding method according to another embodiment of the present invention.

The video encoding apparatus 140 of the encoding apparatus 100 according to another embodiment of the present invention may determine a region which is spatially neighboring the current region, acquire a filtering parameter of the determined region, perform selective filtering processing for a boundary region between the current region and the neighboring region using the filtering parameter, generate signaling information according thereto, and deliver the signaling information to the decoding apparatus 200.

Accordingly, FIG. 21 is a flow chart illustrating an embodiment of processing selective filtering for a prediction sample by the decoding apparatus 200, and referring to FIG. 21, the decoding apparatus 200 performs entropy decoding on an inputted bitstream through the entropy decoding unit 210 (S101), processes reverse quantization and reverse transform through the reverse quantization/reverse transform unit 220 (S103), and acquires a restoration block by performing motion compensation prediction processing on the current block through the intra prediction unit 230 (S105).

And, the decoding apparatus 200 may identify the current region, to which the current block belongs, through the filtering unit 250 (S107), identify a boundary region between the current region and the neighboring region corresponding to the current region (S109), and apply selective filtering corresponding to the inter-region boundary region (S111).

Here, the selective filtering may include a process of acquiring encoded condition information or separate signaling information from the encoding apparatus 100 for the boundary region of different or neighboring regions, and processing selective and adaptive decoding of loop filtering (in-loop filter) for the boundary region between a plurality of different regions.

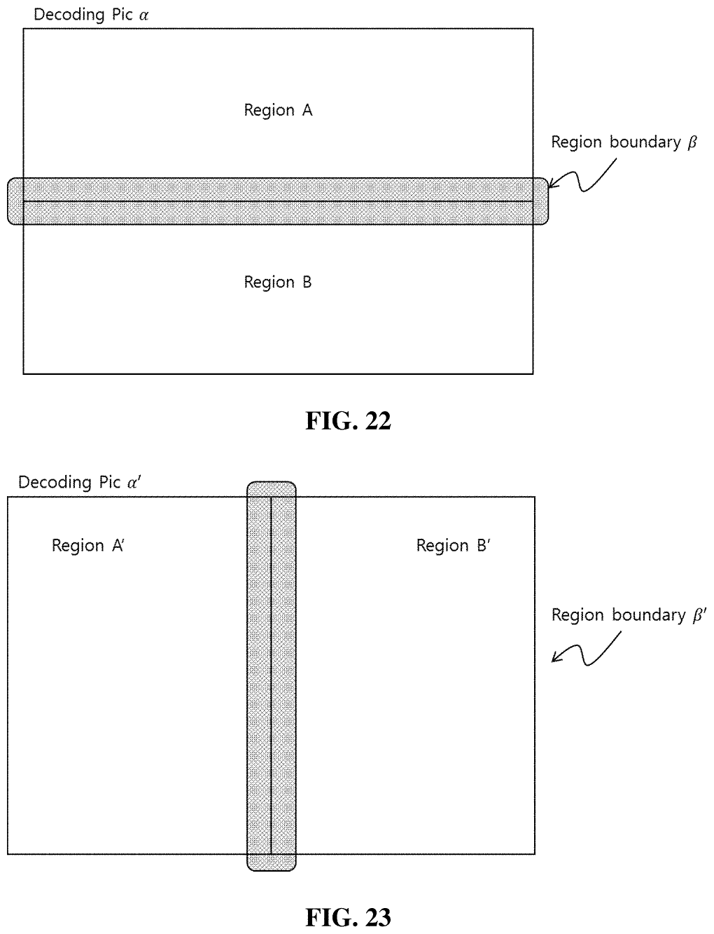

The filtering and the parameter like this will be described in more detail through FIG. 22 to FIG. 29.

FIG. 22 to FIG. 24 show a case of applying selective filtering in the boundary region between different regions.

First, referring to FIG. 22, when a decoding video picture (decoding pic a) includes a video matched to two different regions (Region a and Region b) as shown in FIG. 22, in performing decoding of boundary region β according to matching of Region a and Region b, the filtering unit 250 may acquire conditions for performing loop filtering and a filtering parameter using decoding condition information for decoding blocks belonging to boundary region β or a separately delivered signaling value, and perform selective and adaptive loop filtering according to the filtering parameter.

When one sheet of decoding picture is configured of multiple matching videos, the selective and adaptive loop filtering like this may be complexly applied according to the direction of each boundary region.

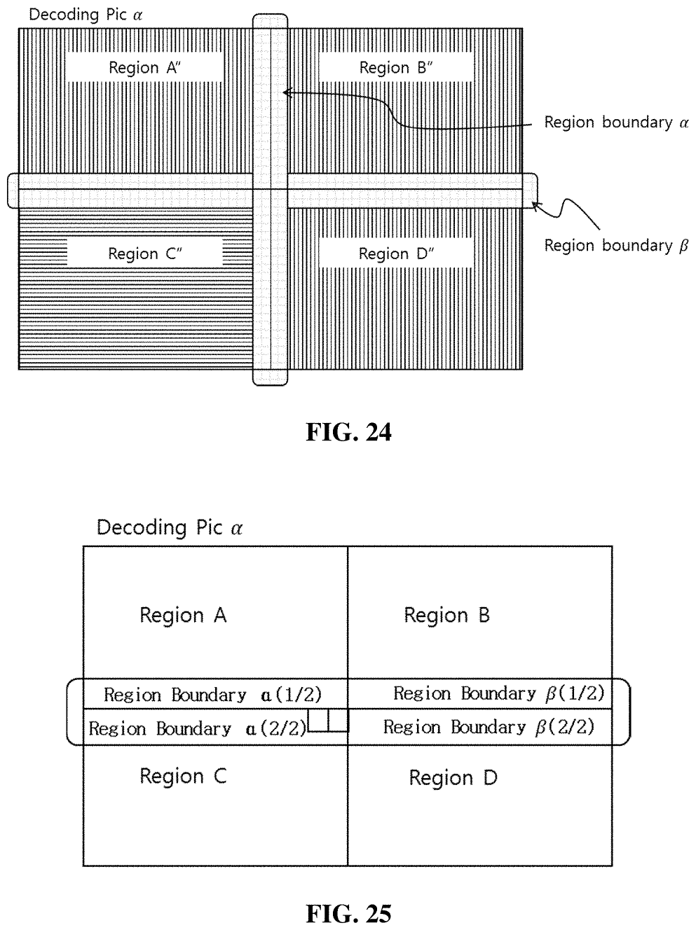

FIG. 22 to FIG. 24 show input videos and boundary regions like this, and they may be implemented as being matched in the vertical direction as shown in FIG. 22, as being matched in the horizontal direction as shown in FIG. 23, or in a complexly matched form as shown in FIG. 24, and boundary regions according thereto may be generated.

More specifically, the filtering unit 250 may acquire separately signaled information for the region boundary region to acquire a filtering parameter or selectively and adaptively determine whether or not to apply filtering of the blocks in each region boundary region according to decoding condition information set in advance.

Here, a smoothing filter such as a LPF (Low Pass Filter) may be illustrated as filtering and applied with being merged with the HEVC standard coding technique such as Adaptive Offset (SAO), De-blocking Filter or the like, or a filter technique such as an Adaptive Loop Filter or the like. And, whether or not to apply filtering like this may be selectively and adaptively turned On/Off in the region boundary region.

For example, when a neighboring region corresponds to a video continued according to the view port, filtering needs to be turned on for improvement of subjective video quality. Therefore, LPF may be applied to the blocks belonging to a corresponding boundary region to encode the blocks.

In addition, when the neighboring region corresponds to a video between regions that is not continuous according to the view port, encoding the blocks belonging to a corresponding boundary without applying the LPF may be rather helpful for improving video quality and encoding efficiency.

Therefore, filtering for each region boundary region needs to be selectively applied.

When filtering is applied, the encoding apparatus 100 may transmit whether or not to apply a filter by the unit of a separate block to the decoding apparatus 200 through an On/Off flag or the like. In addition, the decoding apparatus 200 may separately receive a signal indicating whether or not to apply a filter according to a signaled boundary from the header information of a video, such as a picture or a slice, and determine whether or not to apply a filter.

When filtering is not applied, the encoding apparatus 100 may transmit whether or not to apply a filter by the unit of a separate block to the decoding apparatus 200 through an On/Off flag or the like. In addition, the decoding apparatus 200 may separately receive a signal indicating whether or not to apply a filter according to a signaled boundary from the header information of a video, such as a picture or a slice, and determine whether or not to apply a filter.

Referring to FIG. 25, FIG. 25 shows an application example of an adaptive in-loop filter more specifically.

As shown in FIG. 25, a decoding picture (Decoding pic a) may be configured of four regions of A, B, C and D. Here, it may be assumed that Region A, B and D are videos acquired from a view port of vertical pattern, and region C is a video acquired from a view port of horizontal pattern. Here, the view port may correspond to different perspectives forming a relation according to each pattern, and a video of each view port is acquired when the video is acquired and may be matched and merged.

And, in FIG. 25, Region boundary a, which is a region boundary region, may be divided into Region Boundary α(1/2) as a first boundary region, which is a boundary region where Region A and Region B are matched, and Region Boundary α(2/2) as a second boundary region, which is a boundary region where Region C and Region D are merged.

And, Region boundary β, which is a region boundary region, may be divided into Region Boundary β(1/2) as a third boundary region, which is a boundary region where Region A and Region C are merged, and Region Boundary β(2/2) as a fourth boundary region, which is a boundary region where Region B and Region D are matched.

And, in loop filtering of the decoding picture a, the filtering unit 250 may decode a parameter indicating whether or not to apply a filter, separately received for the decoding blocks belonging to Region Boundary α(1/2), which is the first boundary region, and determine whether or not to apply a filter to the boundary between Region A and Region B.

At this time, although the filtering unit 250 determines to perform filtering on the blocks belonging to Region Boundary α(1/2), which is the first boundary region, it may be determined the same or different filtering to Region Boundary α(1/2) is applied to Region Boundary α(2/2), which is the second boundary belonging to a boundary region between regions, different from the first boundary region among the same Region Boundary α.

On the other hand, the filtering unit 250 may decode a parameter indicating whether or not to apply a filter, separately received for the decoding blocks belonging to Region Boundary β(1/2), and determine whether or not to apply a filter to the boundary between Region A and Region C.

At this time, the filtering unit 250 may not perform filtering on the blocks belonging to Region Boundary β(1/2), and it may be determined the same or different filtering to Region Boundary β(1/2) is applied to Region Boundary β(2/2), which is a boundary region between different regions among the same Region Boundary β.

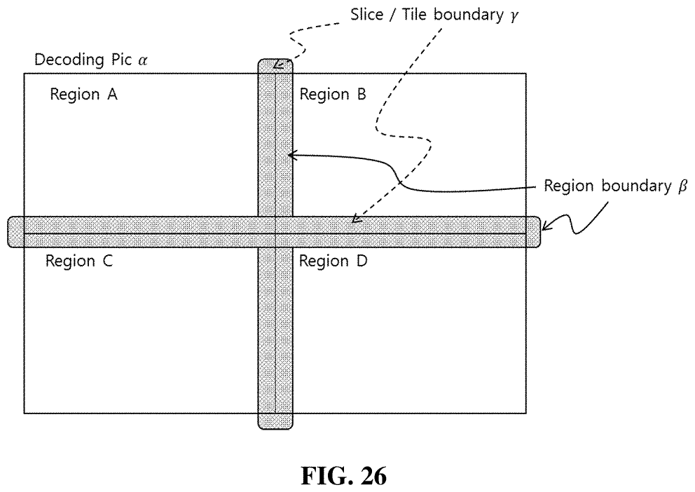

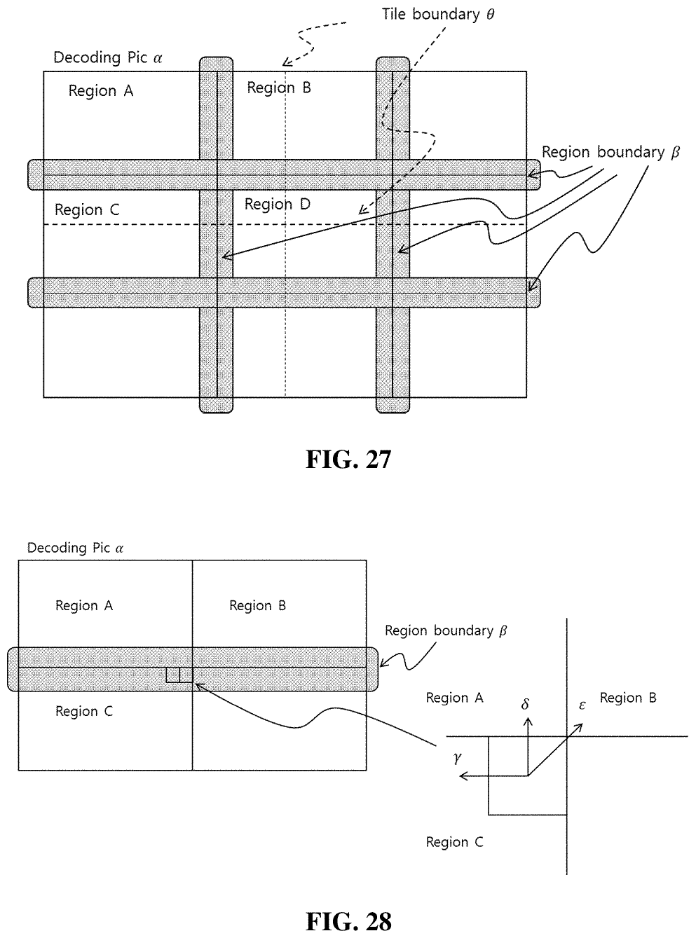

On the other hand, referring to FIG. 26 and FIG. 27, a boundary between regions may be positioned on the boundary of a slice or tile, which is an encoding unit video of an encoded video as shown in FIG. 26 or may not be positioned thereon as shown in FIG. 27.

According to an embodiment of the present invention, the region selective and adaptive filtering of a block may be determined equally or differently according to whether the block is positioned on the boundary between regions or on the boundary between encoding unit videos. For example, this can be selectively and adaptively determined according to the video characteristic of the region.

For this, the filtering unit 250 according to an embodiment of the present invention may acquire a parameter indicating whether or not to apply filtering in a region boundary region through the header information according to encoding unit division of a picture, such as a tile or a slice.

For example, the filtering parameter may include a parameter indicating whether or not to apply filtering (e.g., LPF, SAO, additional deblocking or the like) in a region boundary region through the header information of a slice or a tile, and the filtering unit 250 may selectively and adaptively determine whether or not to apply filtering on the block boundary, region boundary, and tile and slice boundary by parsing the parameter, and perform filtering processing.

On the other hand, when the region boundary is different from the slice or tile boundary, the filtering unit 250 may separately receive, parse and decode a filtering parameter corresponding to the region boundary region and perform filtering according thereto.

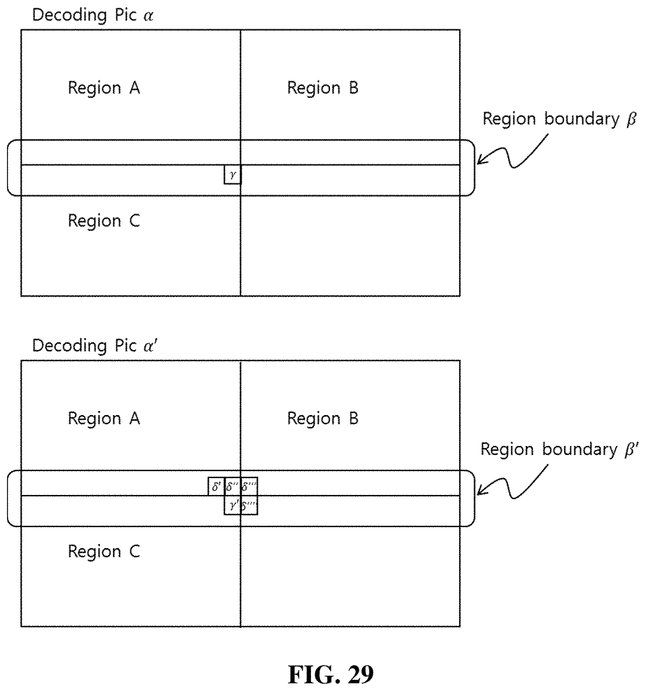

On the other hand, referring FIG. 28 and FIG. 29, in processing intra prediction decoding or inter prediction decoding, the intra prediction unit 230 according to an embodiment of the present invention may refer to block information filtered for the boundary region.

More specifically, the intra prediction unit 230 or the motion compensation prediction unit 240 may enhance intra prediction processing efficiency by using a filtering result of the filtering unit 250.

For example, when filtering is processed on a region boundary region, the intra prediction unit 230 may perform intra prediction decoding using blocks encoded through intra prediction mode of a neighboring region as a reference sample.

In addition, when filtering is processed on a region boundary region, the motion compensation prediction unit 240 may perform inter motion compensation prediction decoding using blocks encoded through intra prediction mode of a neighboring region as a reference sample.

For this, when a region reference sample of a currently decoded block is configured, the filtering unit 250 may configure a reference sample by padding blocks on which filtering is performed, and the intra prediction unit 230 or the motion compensation prediction unit 240 may perform intra or inter prediction decoding using the reference sample configured by padding.

FIG. 29 shows a view of configuring a reference sample by padding blocks, on which filtering is performed, to perform intra or inter prediction decoding, and filtered neighboring blocks within a boundary region may be padded to be configured as a reference sample for intra or motion compensation prediction.

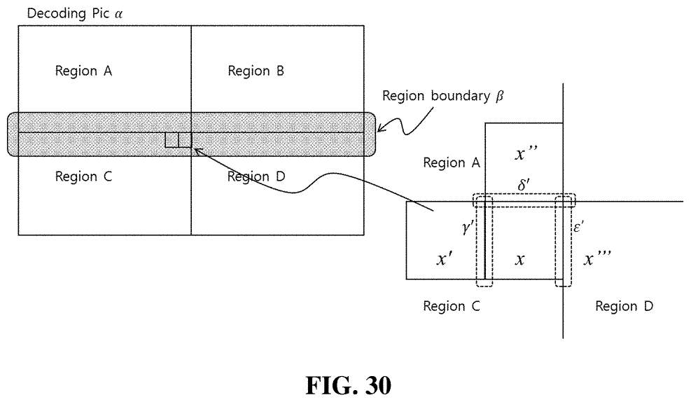

On the other hand, FIG. 30 is a view for explanation of another embodiment of the present invention, and in performing filtering of block x restored through the intra or inter prediction, decoding block x may form block boundaries and region boundaries with block x′ belonging to the same region and blocks x″ and x′″, which are blocks neighboring while belonging to other regions.

Here, a filtering parameter may be determined according to boundary γ′ between decoding block x and a neighboring block belonging to the same region, and boundaries δ′ and ε′ between decoding block x and neighboring blocks belonging to different regions, and accordingly, whether or not to apply filtering and strength of the filtering may be selectively and adaptively determined.

More specifically, when block x″ positioned in another Region A has a continuous view port relation with respect to the current encoding block x belonging to Region C, the filtering unit 250 may apply selective and adaptive filtering to boundary δ′ of the region and the block. In addition, information on whether or not to apply filtering may be delivered from the encoding apparatus 100 through a separate flag signal.

Here, continuous view port information may be acquired from spatial layout information, acquired from separately signaled view port information, or acquired according to video analysis. In addition, for example, when view port indexes are continuous to each other or in a relation adjacent to each other, it may be said that there is a continuous view port relation.

And, in this case, in the ALF, SAO or De-block processing, the filtering unit 250 may determine whether or not to apply filtering and strength of the filtering by parsing the signaling signal.

In the case of configuration like such, since a smoothing filter processing effect is applied to the view port boundary face, blocking artifact generating on the boundary between blocks can be removed.

[First Signaling Method]

On the other hand, when Region C and Region D are not continuous videos, the filtering unit 250 may not apply filtering to block boundary ε′ between neighboring blocks x and x′″. In addition, for blocks x and x′ belonging to the same Region C, whether or not to apply filtering and strength of the filtering may be separately determined according to a separately signaled selective and adaptive filtering parameter.

On the other hand, the filtering parameter according to an embodiment of the present invention may be transmitted with being included in the decoding information of a block. For example, the filtering parameter is a filtering flag parameter of On/Off and may be transmitted in correspondence to each encoding block.

For example, although decoding blocks are the same, whether or not to apply filtering according to the boundary of a block may be applied differently according to the region boundary, and this can be signaled as a separate On/Off flag, like Index (0=Top, 1=Left, 2=Right), and the filtering unit 250 may determine whether or not to apply filtering to a region boundary face according thereto.

On the other hand, a separate filtering parameter may not be transmitted for the Bottom boundary of a block. Whether or not to apply filtering to the Bottom boundary may be determined when filtering of a bottom block positioned on the Bottom boundary face is performed according to Z Scan decoding order.

[Second Signaling Method]

In addition, the filtering parameter may be delivered through region header information for delivering information on a region, and the region header information may include at least one of ON/OFF parameter indicating whether or not to apply filtering, continuity between region boundaries, and information on division size of a region. In addition, the filtering parameter may be signaled through a separate channel.

[Third Signaling Method]

On the other hand, the filtering parameter may include the header information corresponding to a tile, a slice or a picture as an encoding unit. For example, information on a region and information on whether or not to apply filtering to the region boundary may be delivered with being added to the header information, and the filtering unit 250 may selectively and adaptively determine whether or not to apply filtering between boundaries by parsing each header information.

However, the signaling method is not limited, and the filtering unit 250 may directly derive the filtering parameter by identifying a boundary region in the decoding process or may acquire the filtering parameter from separately signaled spatial layout information and process the filtering parameter.

In addition, the operation of the filtering unit 250 according to an embodiment of the present invention may be processed by the post-processing apparatus 20, as well as the decoding apparatus 200. For example, the post-processing apparatus 20 may further perform selective and adaptive filtering on the boundary region of a video decoded by the decoding apparatus using the spatial layout information.

The method according to the present invention described above may be produced as program for implementation at computer and may be stored in recording medium readable by computer, wherein example of recording medium readable by computer may include ROM, RAM, CD-ROM, magnetic tape, floppy disk, light data storage apparatus, and the like.

The recording medium readable by computer may be distributed on computer system connected by network, and code readable by computer may be stored and implemented in distributed way. And, functional program, code and code segments for realizing the method may be inferred by programmers of technical field in which the present invention belongs to with ease.

And, some desirable embodiments of the present invention were depicted and described above, the present invention is not limited to such specific embodiments, but a variety of changed implementation may be of course possible by a person with ordinary knowledge in the technical field in which the present invention belongs to without escaping from the gist of the present invention stated in claims, and these modified implementation should be understood as not to be separate from technical idea or perspective of the present invention.

According to an embodiment of the present invention, spatial layout information optimized for encoding and transmission is extracted and signaled from synchronized multi-view video, to reduce efficiently amount of transmission data, bandwidth and complexity of video.

And, at decoding end, in case that synchronized multi-view video is received, since partial decoding optimized to each view point and selective decoding can be performed according to the signaling information, system waste can be reduced, by which an encoding/decoding method and apparatus which is efficient in the aspect of complexity and battery consumption can be provided.

And, according to an embodiment of the present invention, by allowing support for spatial layout information on a variety of types of synchronized video, relevant video play according to decoding apparatus specification becomes available, by which apparatus compatibility can be improved.

In addition, the present invention has an advantage of preventing illumination inconsistence in advance and greatly improving subjective video quality according thereto by applying filtering to a motion compensation prediction block or a motion-compensated block and processing adaptive filtering according thereto by using an illuminance compensation parameter for illumination compensation for each synchronized view region or region of a synchronized multi-view videos.

In addition, the present invention has an advantage of preventing degradation of subjective video quality and optimizing encoding and decoding efficiency by processing selective filtering on a boundary region generated in a synchronized view region of a synchronized multi-view video or a boundary between regions.

What is claimed is:

1. A decoding method performed by a decoding apparatus, the method comprising the steps of:
performing decoding of a current block on a current picture configured of a plurality of temporally or spatially synchronized regions, wherein
the performing decoding includes the step of performing a decode processing of the current block using region information corresponding to the plurality of regions.

2. The method according to claim 1, wherein the step of performing decoding includes the step of performing a motion prediction decoding of the current block, wherein the step of performing a motion prediction decoding includes the steps of:
deriving a neighboring reference region corresponding to a region to which the current block belongs;
acquiring an illumination compensation parameter of the reference region; and
processing illumination compensation of the current block, on which the motion prediction decoding is performed, using the illumination compensation parameter.

3. The method according to claim 1, wherein the step of performing decoding includes the steps of:
identifying a boundary region between a region to which the current block belongs and a neighboring region; and
applying selective filtering corresponding to the boundary region.

4. The method according to claim 1, wherein the plurality of regions is temporally synchronized and respectively corresponds to a plurality of face indexes configuring the current picture.

5. The method according to claim 2, wherein the step of performing illumination compensation includes the steps of:
generating a motion prediction sample corresponding to the current block;
applying the illumination compensation parameter to the motion prediction sample; and
acquiring a restoration block by matching the motion prediction sample, to which the illumination compensation parameter is applied, and a residual block.

6. The method according to claim 5, wherein the step of performing illumination compensation includes the steps of:
generating a motion prediction sample corresponding to the current block;
acquiring a restoration block by matching the motion prediction sample and the residual block; and
applying the illumination compensation parameter to the restoration block.

7. The method according to claim 6, wherein the illumination compensation parameter includes an illumination scale parameter and an illumination offset parameter determined in advance in correspondence to the plurality of regions, respectively.

8. The method according to claim 3, further comprising the step of performing adaptive filtering when the illumination-compensated block is positioned in a boundary region between the current region and the neighboring region.

9. The method according to claim 8, wherein the step of performing decoding further includes the step of acquiring a filtering parameter for the selective filtering.

10. The method according to claim 8, wherein the boundary region includes a horizontal boundary region, a vertical boundary region, and a complex boundary region, and the filtering parameter is determined in correspondence to the horizontal boundary region, the vertical boundary region, and the complex boundary region.

11. The method according to claim 8, wherein the filtering parameter is included in header information of each encoding unit of video information.

12. A decoding apparatus of a decoding method performed by the decoding apparatus, the apparatus comprising:
a video decoding unit performing decoding of a current block on a current picture configured of a plurality of temporally or spatially synchronized regions; and
a processing unit performing decode processing of the current block using region information corresponding to the plurality of regions.

13. The apparatus according to claim 12, wherein the processing unit includes an illumination compensation processing unit deriving, when motion prediction decoding of the current block on the current picture is performed, a neighboring reference region corresponding to a region to which the current block belongs, acquiring an illumination compensation parameter of the reference region, and processing illumination compensation of the current block, on which the motion prediction decoding is performed, using the illumination compensation parameter.

14. The apparatus according to claim 12, wherein the processing unit includes a filtering unit identifying a boundary region between a region to which the current block belongs and a neighboring region, and applying selective filtering corresponding to the boundary region.
